(19) United States
(12) Patent Application Publication
(10) Pub. No.: US 2025/0297061 A1
(43) Pub. Date: Sep. 25, 2025

(54) NEW POLYMERS FOR BATTERY APPLICATIONS

(71) Applicant: OXFORD UNIVERSITY INNOVATION LIMITED, Oxford (GB)

(72) Inventors: Charlotte WILLIAMS, Oxford (Oxfordshire) (GB); Georgina GREGORY, Oxford (Oxfordshire) (GB); Holly YEO, Oxford (Oxfordshire) (GB); Peter BRUCE, Oxford (Oxfordshire) (GB); Mauro PASTA, Oxford (Oxfordshire) (GB)

(21) Appl. No.: 18/845,901

(22) PCT Filed: Mar. 16, 2023
(86) PCT No.: PCT/GB2023/050635

§ 371 Date: Sep. 11, 2024

(30) Foreign Application Priority Data
Mar. 17, 2022 (GB) 2203753.5

(51) Int. Cl. C08G 64/18; H01M 4/02; H01M 4/62; H01M 10/0565

(52) U.S. Cl. CPC C08G 64/18; H01M 4/622; H01M 10/0565; H01M 2004/028; H01M 2300/0082

(57) ABSTRACT

New block polymers are described, as well as processes for preparing them using ring-opening polymerisation and ring-opening copolymerisation techniques. Also described are electrolytes, cathodes and batteries comprising the polymers.

### CROSS-REFERENCE TO RELATED APPLICATIONS

This application is the National Stage of International Application No. PCT/GB2023/050635, filed Mar. 16, 2023, which claims priority to GB 2203753.5, filed Mar. 17, 2022, which are entirely incorporated herein by reference.

### INTRODUCTION

The present invention relates to polymers for use in batteries and battery components. The invention also relates to batteries and battery components (e.g., electrolytes and cathodes) comprising the polymers, as well as to processes for preparing the polymers and battery components.

### BACKGROUND OF THE INVENTION

The sale of new petrol and diesel vehicles will be phased out by 2030 in the UK.^{[1]} This is important for increasing the sustainability of transport through the reduction of greenhouse gas emissions and reliance on fossil fuels. However, significant technological advancements are required to increase the appeal of electric vehicles; an experience mirroring internal combustion engine vehicles is desired. This means; fast-charging time; long battery lifetime; high safety standards; and high battery capacity. These demands can be addressed through developing better batteries.

Batteries consist of an electrolyte which separates two electrodes: the anode and the cathode. Their role is to store and release lithium. The electrolyte facilitates ion transport between the electrodes. Traditionally, electrolytes are flammable liquids; these are often unstable with developing high-capacity electrodes, such as Li metal anodes, and they present safety concerns.^{[2]} Solid state electrolytes are an important area of battery research.^{[3]} They can be broadly categorized as ceramic or polymeric. Sulfide and oxide materials have been the focus of ceramic research, such as Li_{9.6}P₃S₁₂ and Li₇La₃Zr₂O₁₂.^{[4]} They typically have excellent conductivity and can avoid the formation of dendrites (inhomogeneous lithium deposition on the anode whilst charging, which can lead to short-circuiting and explosions). However, they can face issues with flexibility, processability, and electrode-electrolyte interface stability.^{[5}] Where inorganic electrolytes fail, polymer electrolytes largely succeed. Solid polymer electrolytes (SPEs) have enhanced resistance to variations in electrode volume, improved processability, and are often flexible.^{[3a]}

Polymers can play another key role in the battery: as a binder material. PVDF, a fluorinated polymer, is widely used in batteries to adhere the cathode particles. However, PVDF is insufficiently adhesive and flexible to operate with high-capacity cathodes: the cathode undergoes significant expansion and contraction on charge and discharge, causing contact loss with the binder and deterioration in electrochemical performance. Consequently, new polymer binders are sought which are electrochemically stable, flexible, and adhesive.^{[6]}

The first polymer electrolyte was reported in 1973 by Fenton et al. and consisted of polyethylene oxide (PEO) with alkali salts.^{[7]} PEO has a flexible backbone and the ether oxygens are good donors so are able to solvate Li⁺, resulting in ionically conducting polymer salts. Ion transport only occurs in amorphous regions above the T_{g} as it is assisted by the segmental motion of the polymer chains.^{[3a]} Extensive research and optimization of PEO-based electrolytes has been conducted through approaches such as co-polymerization, cross-linking, and blending.^{[8]} However, many still have poor room temperature ionic conductivity (<10⁻⁴ S cm⁻¹, compared to around 10⁻² S cm⁻¹ for conventional liquid electrolytes) and insufficient electrochemical stability (<4 V).^{[9]}

In spite of the advances made in this field, there remains a need for structurally well-defined polymeric materials having electrochemical and mechanical properties making them suitable for use in batteries and battery components.

The present invention was devised with the foregoing in mind.

### SUMMARY OF THE INVENTION

According to a first aspect of the present invention there is provided a polymer having a structure according to Formula I:

A-B-A′ (I)
wherein
A is a polycarbonate block;
A′ is absent or is a polycarbonate block A; and
B is different to A and is a block composed of a poly(ester-co-carbonate) or a polycarbonate.

According to a second aspect of the present invention there is provided a process for the preparation of a polymer, the process comprising the steps of:
(a) performing ring-opening polymerisation of: (i) a cyclic carbonate or (ii) a mixture of a cyclic carbonate and a cyclic ester to form a polymeric block B being a polycarbonate or a poly(ester-co-carbonate); and
(b) growing a polymeric block A on one or both ends of the polymeric block B by ring-opening copolymerisation of: (i) an epoxide or an oxetane, and (ii) carbon dioxide.

According to a third aspect of the present invention there is provided a polymer obtained, directly obtained or obtainable by the process of the second aspect.

According to a fourth aspect of the present invention there is provided an electrolyte comprising a mixture of a polymer of the first or third aspect and a metal salt.

According to a fifth aspect of the present invention there is provided a process for making an electrolyte, the process comprising the step of:
(i) preparing a polymer according to the process of the second aspect; and
(ii) mixing the polymer with a metal salt.

According to a sixth aspect of the present invention there is provided a cathode for a battery, the cathode comprising a polymer of the first or third aspect, and/or an electrolyte of the fourth aspect.

According to a seventh aspect of the present invention there is provided a battery comprising a polymer of the first or third aspect, an electrolyte of the fourth aspect, and/or a cathode of the sixth aspect.

According to an eighth aspect of the present invention there is provided a use of a polymer of the first or third aspect in the manufacture of a battery or a battery component.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein refers to straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl, hexyl and the like. Most suitably, an alkyl may have 1, 2, 3 or 4 carbon atoms.

The term “alkylene” as used herein refers to a divalent equivalent of an alkyl group as described above.

The term “alkenyl” as used herein refers to straight or branched chain alkenyl moieties, typically having 1, 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 1, 2, 3, 4, 5 or 6 carbon atoms. The term includes reference to alkynyl moieties containing 1, 2 or 3 carbon-carbon triple bonds (C≡C). This term includes reference to groups such as ethynyl, propynyl, butynyl, pentynyl and hexynyl.

The term “alkoxy” as used herein refers to —O-alkyl, wherein alkyl is a straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “aryl-(m-nC)alkyl” means an aryl group covalently attached to a (m-nC)alkylene group, both of which are described herein. Examples of aryl-(m-nC)alkyl groups include benzyl, phenylethyl, and the like.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of heteroaryl groups are monocyclic and bicyclic groups containing from five to twelve ring members, and more usually from five to ten ring members.

The heteroaryl group can be, for example, a 5- or 6-membered monocyclic ring or a 9- or 10-membered bicyclic ring, for example a bicyclic structure formed from fused five and six membered rings or two fused six membered rings. Each ring may contain up to about four heteroatoms typically selected from nitrogen, sulfur and oxygen. Typically, the heteroaryl ring will contain up to 3 heteroatoms, more usually up to 2, for example a single heteroatom.

The term “heteroaryl-(m-nC)alkyl” means an heteroaryl group covalently attached to a (m-nC)alkylene group, both of which are described herein.

The term “carbocyclyl”, “carbocyclic” or “carbocycle” means a non-aromatic saturated or partially saturated monocyclic, or a fused, bridged, or spiro bicyclic carbocyclic ring system(s). Monocyclic carbocyclic rings contain from about 3 to 12 (suitably from 3 to 7) ring atoms. Bicyclic carbocycles contain from 7 to 17 carbon atoms in the rings, suitably 7 to 12 carbon atoms, in the rings. Bicyclic carbocyclic rings may be fused, spiro, or bridged ring systems.

The term “heterocyclyl”, “heterocyclic” or “heterocycle” means a non-aromatic saturated or partially saturated monocyclic, fused, bridged, or spiro bicyclic heterocyclic ring system(s). Monocyclic heterocyclic rings contain from about 3 to 12 (suitably from 3 to 7) ring atoms, with from 1 to 5 (suitably 1, 2 or 3) heteroatoms selected from nitrogen, oxygen or sulfur in the ring. Bicyclic heterocycles contain from 7 to 17 member atoms, suitably 7 to 12 member atoms, in the ring. Bicyclic heterocyclic(s) rings may be fused, spiro, or bridged ring systems.

The term “halogen” or “halo” as used herein refers to F, Cl, Br or I. In a particular, halogen may be F or Cl, of which Cl is more common.

The term “haloalkyl” is used herein to refer to an alkyl group in which one or more hydrogen atoms have been replaced by halogen (e.g. fluorine) atoms. Often, haloalkyl is fluoroalkyl. Examples of haloalkyl groups include —CH₂F, —CHF₂ and —CF₃.

The term “substituted” as used herein in reference to a moiety means that one or more, especially up to 5. Preferably, “substituted” as used herein in reference to a moiety means that 1, 2 or 3, of the hydrogen atoms in said moiety are replaced independently of each other by the corresponding number of the described substituents. Even more preferred, “substituted” as used herein in reference to a moiety means that 1 or 2, of the hydrogen atoms in said moiety are replaced independently of each other by the corresponding number of the described substituents.

The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (wt. % or % w/w), said weight percentage refers to the percentage of said component by weight relative to the total weight of the product as a whole. It will be understood by those skilled in the art that the sum of weight percentages of all components of a product will total 100 wt. %. However, where not all components are listed (e.g. where a product is said to “comprise” one or more particular components), the weight percentage balance may optionally be made up to 100 wt % by unspecified ingredients.

### Polymers

In a first aspect, the present invention provides a polymer having a structure according to Formula I:

A-B-A′ (I)
wherein
A is a polycarbonate block;
A′ is absent or is a polycarbonate block A; and B is different to A and is a block composed of a poly(ester-co-carbonate) or a polycarbonate.

Through detailed investigations, the inventors have devised new polymeric materials having electrochemical and mechanical properties making them suitable for use in batteries and battery components (e.g. electrolytes and cathodes). The polymers can be straightforwardly and flexibly prepared using environmentally friendly raw materials by ring opening polymerisation (ROP) and ring opening copolymerisation (ROCOP) techniques, which afford a high degree of control over the polymer's structure, thereby allowing the polymer's properties to be tuned according to a particular application.

It will be understood that Formula I encompasses di-block copolymers (i.e., when A′ is absent) and tri-block copolymers (i.e., when A′ is a polycarbonate block A).

In embodiments, A′ is absent and the polymer is a di-block copolymer.

In embodiments, A′ is a polycarbonate block A and the polymer is a tri-block copolymer.

The polymer may have a molecular weight (Mₙ) of 10-200 kg mol⁻¹. Suitably, the polymer has a molecular weight (Mₙ) of 15-100 kg mol⁻¹. More suitably, the polymer has a molecular weight (Mₙ) of 20-70 kg mol⁻¹. Most suitably, the polymer has a molecular weight (Mₙ) of 30-55 kg mol⁻¹. The molecular weight (Mₙ) of the polymer can be determined by ¹H NMR integration.

The polymer may comprise 10-70 wt % of block(s) A. The wt % of block(s) A recited herein refers to the total amount of such block(s) present with the polymer. Therefore, where A′ is a polycarbonate block A, the wt % recited herein refers to the total amount of both blocks A (as opposed the amount of each block A). Suitably, the polymer comprises 16-65 wt % of block(s) A. More suitably, the polymer comprises 20-45 wt % of block(s) A. Most suitably, the polymer comprises 30-40 wt % of block(s) A. The wt % of block(s) within the polymer can be determined by ¹H NMR integration.

In embodiments, the polymer is a di-block copolymer and has a molecular weight (Mₙ) of 20-70 kg mol⁻¹ and comprises 20-60 wt % of block(s) A. Suitably, the polymer is a di-block copolymer and has a molecular weight (Mₙ) of 20-60 kg mol⁻¹ and comprises 20-45 wt % of block(s) A. More suitably, the polymer is a di-block copolymer and has a molecular weight (Mₙ) of 35-55 kg mol⁻¹ and comprises 20-35 wt % of block(s) A.

In embodiments, the polymer is a tri-block copolymer and has a molecular weight (Mₙ) of 45-70 kg mol⁻¹ and comprises 25-65 wt % of block(s) A. Suitably, the polymer is a tri-block copolymer and has a molecular weight (Mₙ) of 47-68 kg mol⁻¹ and comprises 30-55 wt % of block(s) A. Suitably, the polymer is a tri-block copolymer and has a molecular weight (Mₙ) of 45-55 kg mol⁻¹ and comprises 30-40 wt % of block(s) A.

The copolymers of the invention are suitably block phase-separated (as opposed to block phase-miscible). Phase separation of the blocks within the copolymer may be indicated by the presence of two distinct glass transition temperatures (T_{g}); one for block A and one for block B.

Block A may have a glass transition temperature (T_{g}) that is ≥20° C. (e.g. 20-120° C.). Suitably, block A has a glass transition temperature (T_{g}) that is ≥60° C. More suitably, block A has a glass transition temperature (T_{g}) that is ≥80° C. Most suitably, block A has a glass transition temperature (T_{g}) that is 90-110° C.

Block B may have a glass transition temperature (T_{g}) that is ≥20° C. (e.g. −60 to 20° C.). Suitably, block B has a glass transition temperature (T_{g}) that is ≥0° C. More suitably, block B has a glass transition temperature (T_{g}) that is ≤−25° C. Most suitably, block B has a glass transition temperature (T_{g}) that is −50 to −30° C.

In embodiments, block A has a glass transition temperature (T_{g}) that is 60-110° C. and block B has a glass transition temperature (T_{g}) that is −55 to −25° C. Suitably, the polymer has a molecular weight (Mₙ) of 20-70 kg mol⁻¹ and comprises 16-65 wt % of block(s) A. More suitably, (1) the polymer is a di-block copolymer and has a molecular weight (Mₙ) of 20-70 kg mol⁻¹ and comprises 20-60 wt % of block(s) A, or (2) the polymer is a tri-block copolymer and has a molecular weight (Mₙ) of 45-70 kg mol⁻¹ and comprises 25-65 wt % of block(s) A.

A proportion of the A and/or B block repeating units may independently comprise a pendant neutral functional group, FG_{N}, and/or a pendant anionic functional group, FG_{A}. Such functional groups can be used to tune the properties (e.g., adhesivity) of the polymer according to the desired battery application. For example, functional groups that are able to participate in hydrogen-bonding can improves the polymer's ability to withstand volume changes that occur during (de)lithiation. Exemplary pendant neutral functional groups, FG_{N} include —P(O)(OH)₂, —COOH, —OH, —SO₃H, —NH₂, —C(O)NH₂, —F, —CF₃ and —CN. Exemplary pendant anionic functional groups, FG_{A} include —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻. The skilled person will be familiar with chemical techniques by which such functional groups can be introduced into some or all of the repeating units forming blocks A and/or B.

In embodiments, a proportion of the A and/or B block repeating units comprise a neutral functional group being —P(O)(OH)₂. The inclusion of phosphonate groups, which can participate in hydrogen-bonding, within the polymer can improve the polymer's ability to withstand volume changes that occur during (de)lithiation.

Block A may have a structure according to Formula A-i:

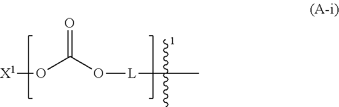

wherein
[symbol] ¹ denotes the point of attachment of an oxygen atom, said oxygen atom being a part of B; L is a linking group separating the two oxygen atoms to which it is attached by a distance of 2-3 carbon atoms; and
X¹ is an end group.

It will be understood by those of skill in the art that the use of square brackets denotes a repeating unit.

Repeating units of the type depicted in Formula A-i can be prepared by ROCOP of CO₂ with an epoxide (e.g., where L separates the two oxygen atoms by a distance of 2 oxygen atoms) or an oxetane (e.g., where L separates the two oxygen atoms by a distance of 3 oxygen atoms). It will be appreciated that a variety of epoxides and oxetanes can be used to form the repeating unit in Formula A-I, some of which are described herein in relation to the second aspect of the invention.

L is suitably a linking group that separates the two oxygen atoms to which it is attached by a distance of 2 carbon atoms. The two carbon atoms may form part of a ring. The ring may be a 5- to 7-membered carbocyclyl or heterocyclyl ring. Most suitably, the ring is a 6-membered carbocyclyl ring.

It will be understood that the end group X¹ can take a variety of forms. Often, X¹ is H.

Block A may have a structure according to Formula A-ii:

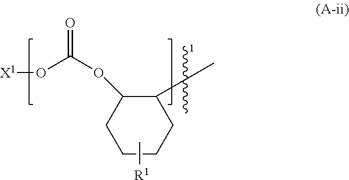

wherein
[symbol] ¹ denotes the point of attachment of an oxygen atom, said oxygen atom being a part of B;
X¹ is an end group; and
each R¹ is independently absent or a group —X—(R²)ᵥ, in which
each R² is independently a pendant neutral functional group FG_{N} or a pendant anionic functional group FG_{A} as defined hereinbefore;
each v is independently 0 or 1; and
each X is (when v is 1) a linking group that links R² to the cyclohexyl ring, or is (when v is 0) a terminal (e.g., monovalent) group.

Repeating units of the type depicted in Formula A-ii can be prepared by ROCOP of CO₂ with a cyclohexene oxide. Since a variety of substituted epoxides of this type are readily available, or can be straightforwardly prepared by known chemistries, it will be appreciated that R¹, when present, can take a variety of forms.

When v is 0, X is a terminal group. For example, X may be a vinyl group that was present on the cyclohexyl ring during polymerisation. Alternatively, X can be a linking group (when v is 1) that connects the cyclohexyl ring to one of the aforementioned functional groups. Continuing with the example of a vinyl group present on the cyclohexyl ring during polymerisation, some of these vinyl groups can, following polymerisation, be reacted with a reagent comprising a R² group (e.g., 2-mercaptoethyl phosphonic acid) to yield a group —X—R², where X is a linking group —CH₂CH₂SCH₂CH₂— and R² is a FG_{N} -P(O)(OH)₂. In this sense, it will be appreciated that block A may comprise a mixture of (divalent) linking and (monovalent) terminal groups X. Furthermore, it will be appreciated that the specific groups mentioned in this paragraph are provided solely for the purpose of illustration, and that a person of ordinary skill in the art will recognise that X can take a variety of forms. Typically, X will be composed of fewer than 80 atoms, more suitably fewer than 40 atoms, even more suitably fewer than 20 atoms.

In embodiments, R¹ is absent, or is

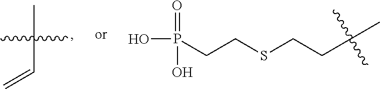

The repeating units of block B, which are not the same as those of block A, can take a variety of forms. For example, block B may be composed of repeating units, each independently having a structure according to Formula B-i:

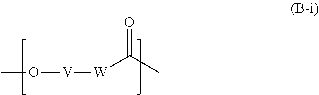

wherein
W is O or CH₂; and
V is a group separating O from W by a distance of 3-5 carbon atoms,
with the proviso that in at least some of the repeating units within block B, W is O.

Suitably, V is a group separating O from W by a distance of 3-4 carbon atoms.

Block B may be a polycarbonate. It will be understood that the repeating units forming block B are different in structure from those repeating units forming polycarbonate block A.

Alternatively, block B is a poly(ester-co-carbonate). Suitably, block B comprises 60-95 mol % of ester repeating units and 5-40 mol % of carbonate repeating units. More suitably, block B comprises 65-90 mol % of ester repeating units and 10-35 mol % of carbonate repeating units. Even more suitably, block B comprises 70-90 mol % of ester repeating units and 10-30 mol % of carbonate repeating units. Most suitably, block B comprises 75-85 mol % of ester repeating units and 15-25 mol % of carbonate repeating units.

Suitably, block B is a poly(caprolactone-co-carbonate) or a poly(ester-co-trimethylene carbonate). More suitably, block B is a poly(caprolactone-co-trimethylene carbonate). It will be understood that the ester and carbonate repeating units may be present in any order within the copolymer (e.g., random or alternating).

In embodiments, B is poly(caprolactone-r-trimethylene carbonate). Suitably, block B comprises 70-90 mol % of caprolactone repeating units and 10-30 mol % of trimethylene carbonate repeating units.

Where the polymer is a di-block copolymer, block B may terminate in any suitable end group. For di-block polymers of the invention, growth of block B may be initiated from the hydroxy group of a monohydroxy chain transfer agent (e.g., methyl benzyl alcohol). In such cases, a residual portion of the chain transfer agent (e.g., all bar the hydrogen atom of the initiating hydroxy group) may form the end group of block B. The end group may have a formula —O—R³ where R³ is an organic group comprising fewer than 50 atoms, more suitably fewer than 25 atoms.

Where the polymer is a tri-block copolymer, growth of block B may be initiated from hydroxy groups of a dihydroxy chain transfer agent (e.g., benzene dimethanol). In such cases, block B may comprise a residual portion of the chain transfer agent (e.g., all bar the hydrogen atoms of the initiating hydroxy groups), which may be located at a position approximately 40-60% along its length. The residual portion may have a formula —O—R⁴—O—, where R⁴ is an organic group comprising fewer than 50 atoms, more suitably fewer than 25 atoms.

Block A may be amorphous. Alternatively/additionally, the polymer itself may be amorphous. Amorphous polymers have no observable melting point when analysed by differential scanning calorimetry.

In a second aspect, the present invention provides a process for the preparation of a polymer, the process comprising the steps of:
(a) performing ring-opening polymerisation of: (i) a cyclic carbonate or (ii) a mixture of a cyclic carbonate and a cyclic ester to form a polymeric block B being a polycarbonate or a poly(ester-co-carbonate); and
(b) growing a polymeric block A on one or both ends of the polymeric block B by ring-opening copolymerisation of: (i) an epoxide or an oxetane, and (ii) carbon dioxide.

The polymers of the first aspect can be straightforwardly prepared by sequential ROP and ROCOP reactions. The use of CO₂ as a reagent in ROCOP is particularly beneficial from an environmental standpoint.

The ROP in step (a) may be initiated using a monofunctional initiator, such as a monohydroxy chain transfer agent (e.g., methyl benzyl alcohol). Where a monofunctional initiator is used in step (a), step (b) comprises growing the polymeric block A on one end of the polymeric block B. The resulting polymer is therefore a di-block copolymer, A-B.

The ROP in step (a) may be initiated using a difunctional initiator, such as a dihydroxy chain transfer agent (e.g., benzene dimethanol). Where a difunctional initiator is used in step (a), step (b) comprises growing the polymeric block A on both ends of the polymeric block B. The resulting polymer is therefore a tri-block copolymer, A-B-A.

The polymeric block B prepared in step (a) may be any of those polymers, and/or have any of those properties (e.g., glass transition temperature (T_{g})) recited hereinbefore in relation to block B of the polymer of the first aspect. Additionally/alternatively, the polycarbonate grown in step (b) may be any of those polycarbonates, and/or have any of those properties (e.g., glass transition temperature (T_{g})) recited hereinbefore in relation to block A of the polymer of the first aspect. Additionally/alternatively, the di/tri-block copolymer prepared by the process may be any of those polymers, and/or have any of those properties (e.g., wt % of block A and/or molecular weight (Mₙ)) recited hereinbefore in relation to the polymer of the first aspect.

The process can be conducted in the presence of a suitable catalyst. Catalysts that are able to catalyse both the ROP of cyclic carbonate and/or cyclic esters and the ROCOP of an epoxide/oxetane with CO₂ are known in the art. Suitably, the catalyst is an organozinc catalyst. A non-limiting example of a catalyst capable of performing both of steps (a) and (b) is:

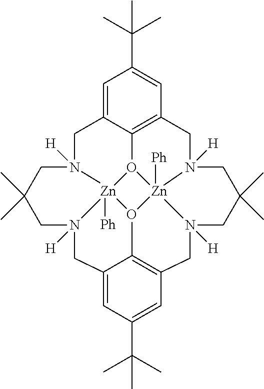

The process can be conducted, if necessary, in a one-pot manner. In other words, steps (a) and (b) can be performed in a sequential manner, without any intervening isolation step. For example, all of the reagents required for performing steps (a) and (b), except CO₂, can be introduced into a reaction vessel, thereby initiating step (a). When desired, step (a) can be terminated and step (b) begun by introducing CO₂ into the reaction vessel.

The process may further comprise an additional step of:
(c) modifying a proportion of the block A and/or block B repeating units by introducing a pendant neutral functional group, FG_{N} and/or a pendant anionic functional group, FG_{A} as described hereinbefore in relation to the first aspect. Suitably, step (c) comprises modifying a proportion of the block A repeating units.

As described hereinbefore in relation to the first aspect, the epoxide/oxetane used in step (b) can take a variety of forms. Suitable oxetanes include 1,3-propylene oxide, 2,2-dimethyl oxetane and 3,3-dimethyl oxetane. Suitable epoxides include 2,3-dimethyl oxirane, terminal epoxides, glycidyl ethers and cyclic epoxides.

Terminal epoxides may have the structure:

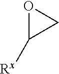

wherein R^{x} is selected from hydrogen, (1-4C)alkyl, (2-4C)alkenyl, (1-4C)haloalkyl, aryl, aryl-(1-2C)alkyl, —(OCH₂CH₂)ᵣOMe and —(CH₂)ₛC(O)O—R^{x1}, in which r is 1-10, s is 0-6 and R^{x1} is (1-5C)alkyl or aryl-(1-2C)alkyl. Particular non-limiting examples of R^{x} inlcude hydrogen, methyl, ethyl, phenyl, —CH₂Cl, —CH═CH₂, —CH₂C(O)OtBu, —C(O)OBn, —(CH₂)₁₋₄C(O)OMe and —(OCH₂CH₂)₁₋₆OMe.

Glycidyl ethers may have the structure:

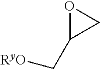

wherein R^{y} is selected from hydrogen, (1-4C)alkyl, (2-4C)alkenyl, (2-4C)alkynyl and —(CH₂)ₜR^{y1}, in which t is 0-4 and R^{y1} is aryl, heteroaryl, carbocyclyl or heterocyclyl, wherein any ring in R^{y} is optionally substituted with one or more groups R^{y2}, and any (1-4C)alkyl in R^{y} is optionally substituted with R^{y3}; each R^{y2} being independently selected from (1-3C)alkyl and nitro, and R^{y3} being (1-4C)alkoxy or aryloxy. Particular non-limiting examples of R^{y} include hydrogen, (1-4C)alkyl, —CH₂OCH₂CH₃, —CH₂O—CH(CH₃)₂, —CH₂—O—C₆H₅ and:

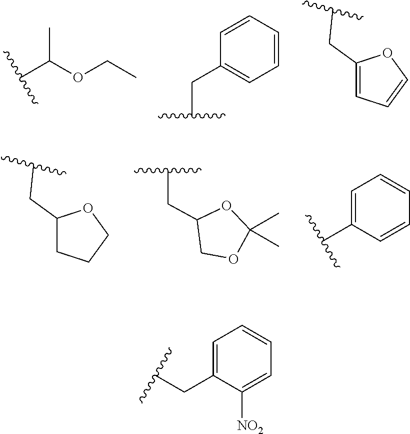

Cyclic epoxides may have the structure:

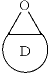

wherein D is a 5- to 7-membered carbocyclic or heterocyclic ring that is optionally fused or sprio-linked to 1 or 2 rings E, wherein each E is independently selected from carbocyclyl, heterocyclyl, aryl and heteroaryl, and wherein any of rings D and E are optionally substituted with one or more substituents R^{z}, each R^{z} being independently selected from (1-4C)alkyl, (2-4C)alkenyl, —(CH₂)₁₋₂Si(OR^{z1})₃, —(CH₂)₁₋₂OSi(R^{z1})₃, and a group -L^{z1}-L^{z2}-R^{z2}, in which R^{z1} is (1-2C)alkyl, L^{z1} is absent or (1-3C)alkylene, L^{z2} is absent, —O— or —C(O)O— and R^{z2} is hydrogen, (1-6C)alkyl, (1-5C)haloalkyl, heterocyclyl, aryl or aryl-(1-2C)alkyl, wherein any ring in R^{z2} is optionally substituted with (1-3C)alkyl or oxo. Particular, non-limiting examples of cyclic epoxides include:

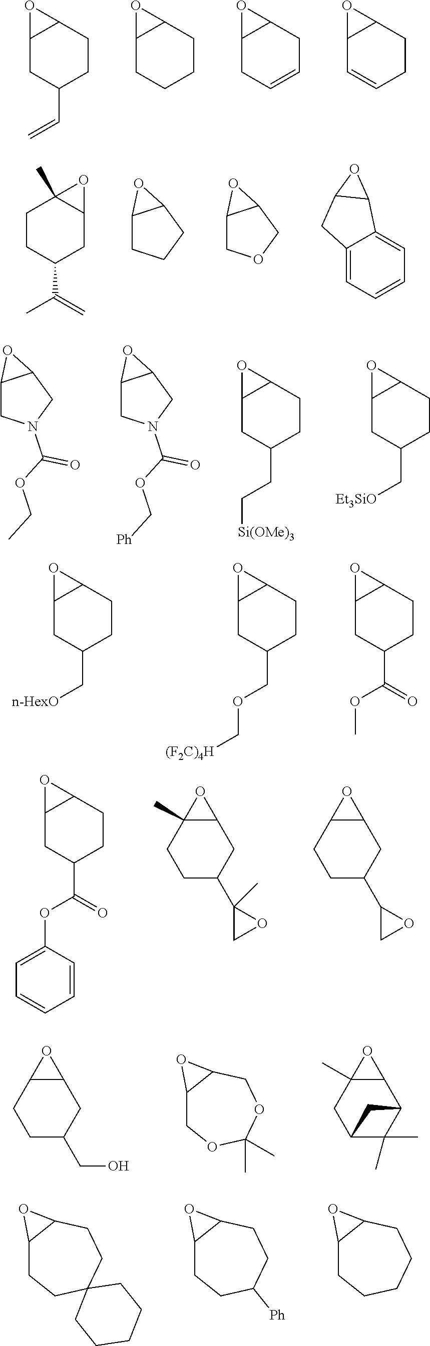

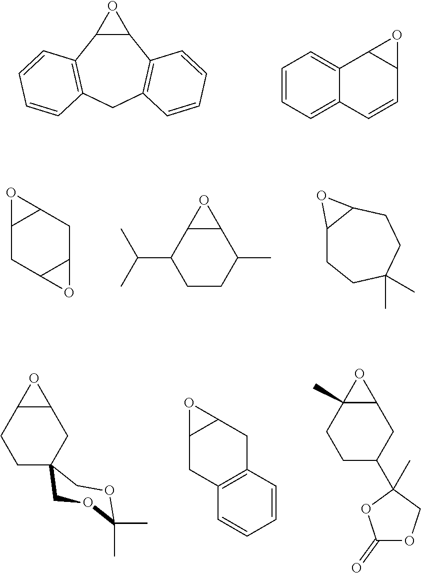

Suitably, the epoxide or oxetane is an epoxide. More suitably, the epoxide is a cyclic epoxide. Even more suitably, the epoxide is a 6-membered cyclic epoxide. Most suitably, the epoxide is selected from;

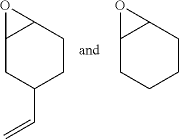

The cyclic carbonates and cyclic esters useful in step (a) of the process can take a variety of forms. For example, the cyclic carbonate may be a 6- to 10-membered cyclic carbonate and the cyclic ester may be a 6- to 10-membered cyclic ester. Suitably, the cyclic carbonate may be a 6- to 8-membered cyclic carbonate and the cyclic ester may be a 6- to 8-membered cyclic ester. Most suitably, the cyclic carbonate is trimethylene carbonate and the cyclic ester is ε-caprolactone.

In embodiments, step (a) comprises performing ring-opening polymerisation of a cyclic carbonate to form a polymeric block B being a polycarbonate.

In embodiments, step (a) comprises performing ring-opening polymerisation of a mixture of a cyclic carbonate and a cyclic ester to form a polymeric block B being a poly(ester-co-carbonate). Suitably, the mixture comprises 60-95 mol % of the cyclic ester and 5-40 mol % of the cyclic carbonate. More suitably, the mixture comprises 65-90 mol % of the cyclic ester and 10-35 mol % of the cyclic carbonate. Even more suitably, the mixture comprises 70-90 mol % of the cyclic ester and 1-30 mol % of the cyclic carbonate. Most suitably, the mixture comprises 75-85 mol % of the cyclic ester and 15-25 mol % of the cyclic carbonate.

The person of skill in the art will be able to select appropriate conditions (e.g. solvents, temperatures, etc.) for performing the process. A non-limiting example of a suitable solvent for performing steps (a) and (b) is toluene. The process may be carried out at a temperature of 50-150° C. (e.g., 90-110° C.).

Step (b) is suitably conducted at a CO₂ pressure of <2 MPa. More suitably, step (b) is conducted at a CO₂ pressure of <1 MPa. Even more suitably, step (b) is conducted at a CO₂ pressure of <0.5 MPa. Most suitably, step (b) is conducted at a CO₂ pressure of 0.05-0.2 MPa.

In a third aspect, the present invention provides a polymer obtained, directly obtained or obtainable by a process of the second aspect.

### Battery Applications

In a fourth aspect, the present invention provides an electrolyte comprising a mixture of a polymer of the first or third aspect and a metal salt.

The inventors have surprisingly determined that the polymers described herein are particularly suitable for use in an electrolyte, such as for a battery. When mixed with a metal salt, the polymers display good thermal stability and elastic recovery properties. The electrolytes also demonstrate good ionic conductivity at ambient and elevated temperatures, and are oxidatively stable to above 5 V, suggesting compatibility with high voltage cathodes.

The metal salt may be a Na, Li or K salt. Suitably the metal salt is a Li salt.

The metal salt may have the formula M⁺ X⁻, wherein M⁺ is selected from Na⁺, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis[(pentafluoroethyl)sulfonyl]imide, B(CN)₄⁻, 4,5-dicarbonitrile-1,2,3-triazole, perylene diimide, 4,5-dicyano-2-(trifluoromethyl)imidazolium and combinations of two or more thereof. Suitably, M⁺ is Li⁺ and/or X⁻ is bis(trifluoromethanesulfonyl)imide. Most suitably, M⁺ is Li⁺ and X⁻ is bis(trifluoromethanesulfonyl)imide.

The electrolyte may comprise 0.1-80 wt % of the metal salt. Suitably, the electrolyte comprises 15-50 wt % of the metal salt. More suitably, the electrolyte comprises 15-25 wt % of the metal salt. The metal salt is suitably lithium bis(trifluoromethanesulfonyl)imide.

In a fifth aspect, the present invention provides a process for making an electrolyte, the process comprising the step of:
(i) providing a polymer according to the first or third aspect, or preparing a polymer according to the process of the second aspect; and
(ii) mixing the polymer with a metal salt.

Step (ii) may comprise mixing the polymer and metal salt in a solvent. Any suitable solvent may be used. A non-limiting example of a suitable solvent is anhydrous THF.

The process may further comprise a step (iii) of drying the mixture resulting from step (ii). Suitably, the mixture is dried at a temperature of 50-80° C., optionally under vacuum.

In a sixth aspect, the present invention provides a cathode for a battery, the cathode comprising a polymer of the first or third aspect, and/or an electrolyte of the fourth aspect. The cathode is suitably for a Li-ion battery.

The cathode may be a composite cathode. The composite cathode may comprise a cathode material (e.g. LiNi_{0.8}Mn_{0.1}Co_{0.1}O₂, known as NMC811), an electrically conductive additive (e.g. carbon) and either or both of a polymer of the first aspect and an electrolyte of the fourth aspect. The cathode material, electrically conductive additive and polymer and/or electrolyte may be provided as a mixture (e.g., an intimate and substantially homogeneous mixture) within the cathode. Within the composite cathode, particles of the cathode material may be coated with the polymer of the first aspect and/or the electrolyte of the fourth aspect. The composite cathode may also comprise a ceramic electrolyte (e.g., argyrodite Li₆PS₅Cl)

The composite cathode can be prepared by mixing (e.g., ball milling) the powders of the composite cathode components under dry (i.e., solvent-free) conditions, and then forming the resulting powder into a composite cathode (e.g. by cold-pressing under increased pressure).

The composite cathode can also be prepared by mixing the powders of the composite cathode components in a liquid (e.g xylene) to form a slurry and then casting the slurry onto a current collector (e.g., an Al current collector) using, for example, a doctor blade.

The composite cathode can also be prepared by coating the polymer of the first aspect and/or the electrolyte of the fourth aspect onto particles of the cathode material. The coating technique is suitably conducted in solution, followed by drying of the coated particles. The coated particles of the cathode material may then be mixed with the other cathode components (e.g., electrically conductive additive), for example, by a dry or wet technique, as described above.

The cathode may be for an alkali metal ion or an alkali metal battery (e.g., Li, Na or K). The cathode is suitably for a Li-ion or Li-metal battery.

In a seventh aspect, the present invention provides a battery comprising a polymer of the first or third aspect, an electrolyte of the fourth aspect, and/or a cathode of the sixth aspect.

In one arrangement, the battery comprises an electrolyte of the fourth aspect disposed between an anode and a cathode.

In another arrangement, the battery comprises a ceramic electrolyte (e.g., argyrodite Li₆PS₅Cl) disposed between an anode and a cathode, and wherein the battery further comprises an electrolyte of the fourth aspect disposed between the ceramic electrolyte and the cathode and/or anode.

In another arrangement, the battery comprises a cathode of the sixth aspect, wherein a ceramic electrolyte (e.g., argyrodite Li₆PS₅Cl) is disposed between the cathode and an anode, and wherein the cathode comprises an electrically conductive additive (e.g. carbon) and a cathode material (e.g. LiNi_{0.8}Mn_{0.1}Co_{0.1}O₂, known as NMC811), wherein particles of the cathode material are coated with the polymer of the first aspect and/or the electrolyte of the fourth aspect.

The battery may be an alkali metal ion or an alkali metal battery (e.g., Li, Na or K). The battery is suitably a Li-ion or Li-metal battery.

In an eighth aspect, the present invention provides a use of a polymer of the first or third aspect in the manufacture of a battery or a battery component (e.g. an electrolyte or a cathode).

The following numbered statements 1 to 76 are not claims, but instead describe particular aspects and embodiments of the invention:
1. A polymer having a structure according to Formula I:

A-B-A′ (I)
wherein
A is a polycarbonate block;
A′ is absent or is a polycarbonate block A; and
B is different to A and is a block composed of a poly(ester-co-carbonate) or a polycarbonate.
   2 The polymer of statement 1, wherein the polymer has a number average molecular weight (Mₙ) of 10-200 kg mol⁻¹.
   3. The polymer of statement 1, wherein the polymer has a number average molecular weight (Mₙ) of 15-100 kg mol⁻¹.
   4. The polymer of statement 1, wherein the polymer has a number average molecular weight (Mₙ) of 20-70 kg mol⁻¹.
   5. The polymer of statement 1, wherein the polymer has a number average molecular weight (Mₙ) of 30-55 kg mol⁻¹.
   6. The polymer of any one of the preceding statements, wherein the polymer comprises 10-70 wt % of block A.
   7. The polymer of any one of the preceding statements, wherein the polymer comprises 16-65 wt % of block A.
   8. The polymer of any one of the preceding statements, wherein the polymer comprises 30-40 wt % of block A.
   9. The polymer of any one of the preceding statements, wherein A has a glass transition temperature, T_{g}, that is ≥20° C.
   10. The polymer of any one of the preceding statements, wherein A has a glass transition temperature, T_{g}, that is ≥60° C.
   11. The polymer of any one of the preceding statements, wherein A has a glass transition temperature, T_{g}, that is ≥80° C. (e.g., 90-110° C.).
   12. The polymer of any one of the preceding statements, wherein B has a glass transition temperature, T_{g}, that is ≤20° C.
   13. The polymer of any one of the preceding statements, wherein B has a glass transition temperature, T_{g}, that is ≤0° C.
   14. The polymer of any one of the preceding statements, wherein B has a glass transition temperature, T_{g}, that is ≤−25° C. (e.g., −50 to −30° C.).
   15. The polymer of any one of the preceding statements, wherein block A has a glass transition temperature (T_{g}) that is 60-110° C. and block B has a glass transition temperature (T_{g}) that is −55 to −25° C.
   16. The polymer of any one of the preceding statements, wherein A′ is a polycarbonate block A, such that the polymer is a tri-block copolymer.
   17. The polymer of any one of the preceding statements, wherein A′ is absent, such that the polymer is a di-block copolymer.
   18. The polymer of any one of statements 1 to 15, wherein the polymer is a di-block copolymer and has a molecular weight (Mₙ) of 20-70 kg mol⁻¹ and comprises 20-60 wt % of block(s) A.
   19. The polymer of any one of statements 1 to 15, wherein the polymer is a di-block copolymer and has a molecular weight (Mₙ) of 20-60 kg mol⁻¹ and comprises 20-45 wt % of block(s) A.
   20 The polymer of any one of statements 1 to 15, wherein the polymer is a di-block copolymer and has a molecular weight (Mₙ) of 35-55 kg mol⁻¹ and comprises 20-35 wt % of block(s) A.
   21. The polymer of any one of statements 1 to 15, wherein the polymer is a tri-block copolymer and has a molecular weight (Mₙ) of 45-70 kg mol⁻¹ and comprises 25-65 wt % of block(s) A.
   22. The polymer of any one of statements 1 to 15, wherein the polymer is a tri-block copolymer and has a molecular weight (Mₙ) of 47-68 kg mol⁻¹ and comprises 30-55 wt % of block(s) A.
   23. The polymer of any one of statements 1 to 15, wherein the polymer is a tri-block copolymer and has a molecular weight (Mₙ) of 45-55 kg mol⁻¹ and comprises 30-40 wt % of block(s) A.
   24. The polymer of any one of the preceding statements, wherein A has a structure according to Formula A-i:

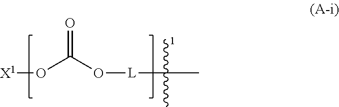

wherein
[symbol] ¹ denotes the point of attachment of an oxygen atom, said oxygen atom being a part of B; L is a linking group separating the two oxygen atoms to which it is attached by a distance of 2-3 carbon atoms; and
X¹ is an end group.
   25. The polymer of statement 24, wherein L is a linking group separating the two oxygen atoms to which it is attached by a distance of 2 carbon atoms.
   26. The polymer of statement 24, wherein L is a linking group separating the two oxygen atoms to which it is attached by a distance of 2 carbon atoms, said 2 carbon atoms forming part of a ring.
   27. The polymer of statement 26, wherein the ring is a 5- to 7-membered carbocyclyl or heterocyclyl ring.
   28. The polymer of statement 26, wherein the ring is a 6-membered carbocyclyl ring.
   29. The polymer of any one of the preceding statements, wherein B is composed of repeating units, each independently having a structure according to Formula B-i:

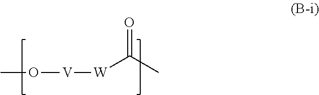

wherein
W is O or CH₂; and
V is a group separating O from W by a distance of 3-5 carbon atoms,
with the proviso that in at least some of the repeating units within block B, W is O.
   30. The polymer of statement 29, wherein V is a group separating O from W by a distance of 3-4 carbon atoms.
   31. The polymer of any one of the preceding statements, wherein a proportion of the A and/or B block repeating units independently comprises a pendant neutral functional group FG_{N} selected from —P(O)(OH)₂, —COOH, —OH, —SO₃H, —NH₂, —C(O)NH₂, —F, —CF₃ and —CN.
   32. The polymer of any one of the preceding statements, wherein a proportion of the A and/or B block repeating units independently comprises a pendant anionic functional group FG_{A} selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.
   33. The polymer of any one of the preceding statements, wherein a proportion of the A and/or B block repeating units comprises a neutral functional group being —P(O)(OH)₂.
   34 The polymer of any one of the preceding statements, wherein a proportion of the A block repeating units comprises a neutral functional group being —P(O)(OH)₂.
   35. The polymer of any one of the preceding statements, wherein A has a structure according to Formula A-ii:

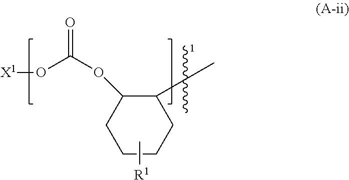

wherein
[symbol] ¹ denotes the point of attachment of an oxygen atom, said oxygen atom being a part of B;
X¹ is an end group; and
each R¹ is independently absent or a group —X—(R²)ᵥ, in which
each R² is independently a pendant neutral functional group FG_{N} or a pendant anionic functional group FG_{A} as defined in statement 31, 32 or 33;
each v is independently 0 or 1; and
each X is (when v is 1) a linking group that links R² to the cyclohexyl ring, or is (when v is 0) a terminal group.
   36. The polymer of statement 35, wherein each X is composed of fewer than 80 atoms.
   37. The polymer of statement 35 or 36, wherein each R¹ is absent, or is:

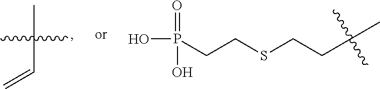

38. The polymer of any one of the preceding statements, wherein B is a poly(ester-co-carbonate).
39. The polymer of any one of the preceding statements, wherein B is poly(caprolactone-co-trimethylene carbonate).
40. The polymer of statement 38 or 39, wherein block B comprises 60-95 mol % of ester repeating units and 5-40 mol % of carbonate repeating units.
41. The polymer of statement 38 or 39, wherein block B comprises 65-90 mol % of ester repeating units and 10-35 mol % of carbonate repeating units.
42. The polymer of statement 38 or 39, wherein block B comprises 70-90 mol % of ester repeating units and 10-30 mol % of carbonate repeating units.
43. The polymer of statement 38 or 39, wherein block B comprises 75-85 mol % of ester repeating units and 15-25 mol % of carbonate repeating units.
44. A process for the preparation of a polymer, the process comprising the steps of: (a) performing ring-opening polymerisation of: (i) a cyclic carbonate or (ii) a mixture of a cyclic carbonate and a cyclic ester to form a polymeric block B being a polycarbonate or a poly(ester-co-carbonate); and
(b) growing a polymeric block A on one or both ends of the polymeric block B by ring-opening copolymerisation of: (i) an epoxide or an oxetane, and (ii) carbon dioxide.
   45. The process of statement 44, wherein ring opening polymerisation in step (a) is initiated using a monofunctional initiator and step (b) comprises growing the polymeric block A on one end of the polymeric block B.
   46. The process of statement 44, wherein ring opening polymerisation in step (a) is initiated using a difunctional initiator and step (b) comprises growing the polymeric block A on both ends of the polymeric block B.
   47. The process of statement 44, 45 or 46, wherein steps (a) and (b) are conducted in a one-pot manner.
   48. The process of statement 47, wherein step (a) is terminated and step (b) is commenced by the addition of carbon dioxide.
   49. The process of any one of statements 44 to 48, wherein step (a) comprises performing ring-opening polymerisation of a mixture of a cyclic carbonate and a cyclic ester to form a polymeric block B being a poly(ester-co-carbonate).
   50. The process of statement 49, wherein the cyclic carbonate is a 6- to 10-membered cyclic carbonate and the cyclic ester is a 6- to 10-membered cyclic ester.
   51. The process of statement 49, wherein the cyclic carbonate is trimethylene carbonate and the cyclic ester is ε-caprolactone.
   52. The process of any one of statements 44 to 51, wherein step (b) comprises growing a polymeric block A on one or both ends of the polymeric block B by ring-opening copolymerisation of: (i) an epoxide, and (ii) carbon dioxide.
   53. The process of statement 52, wherein the epoxide is 2,3-dimethyl oxirane, a terminal epoxide, a glycidyl ethers or a cyclic epoxide.
   54. The process of statement 52, wherein the epoxide is a cyclic epoxide.
   55. The process of statement 52, wherein the epoxide is selected from:

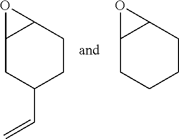

56. The process of any one of statement 44 to 55, further comprising the step of:
(c) modifying a proportion of the block A and/or block B repeating units by introducing:
a pendant neutral functional group selected from —P(O)(OH)₂, —COOH, —OH, —SO₃H, —NH₂, —C(O)NH₂, —F, —CF₃ and —CN; and/or
a pendant anionic functional group selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.
   57. The process of statement 56, wherein step (c) comprises modifying a proportion of the block A and/or block B repeating units by introducing a pendant neutral functional group being —P(O)(OH)₂.
   58. The process of statement 56 or 57, wherein step (c) comprises modifying a proportion of the block A repeating units.
   59. An electrolyte comprising a mixture of a polymer as defined in any one of statements 1 to 43 and a metal salt.
   60. The electrolyte of statement 59, wherein the metal salt is a Na, Li or K salt.
   61. The electrolyte of statement 59, wherein the metal salt is of the formula M⁺ X⁻, wherein M⁺ is selected from Na⁺, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis[(pentafluoroethyl)sulfonyl]imide, B(CN)₄⁻, 4,5-dicarbonitrile-1,2,3-triazole, perylene diimide, 4,5-dicyano-2-(trifluoromethyl)imidazolium and combinations of two or more thereof.
   62. The electrolyte of statement 61 wherein M⁺ is Li⁺.
   63. The electrolyte of statement 61 or 62, wherein X⁻ is bis(trifluoromethanesulfonyl)imide.
   64. The electrolyte of any one of statements 61 to 63, wherein the electrolyte comprises 0.1-80 wt % of the metal salt.
   65. The electrolyte of statement 64, wherein the electrolyte comprises 10-50 wt % of the metal salt.
   66. The electrolyte of statement 64, wherein the electrolyte comprises 15-25 wt % of the metal salt.
   67. A process for making an electrolyte, the process comprising the step of:
(i) preparing a polymer according to the process of any one of statements 44 to 58; and
(ii) mixing the polymer with a metal salt.
   68. A cathode for a battery, the cathode comprising a polymer as defined in any one of statements 1 to 43 or an electrolyte as defined in any one of statements 59 to 66.
   69. The cathode of statement 68, wherein the cathode is a composite cathode comprising a cathode material (e.g. LiNi_{0.8}Mn_{0.1}Co_{0.1}O₂, known as NMC811), an electrically conductive additive (e.g. carbon) and either or both of a polymer as defined in any one of statements 1 to 43 and an electrolyte as defined in any one of statements 59 to 66.
   70. The cathode of statement 69, wherein particles of the cathode material are coated with the polymer and/or the electrolyte.
   71. The cathode of statement 69 or 70, wherein the cathode further comprises a ceramic electrolyte (e.g., argyrodite Li₆PS₅Cl).
   72. A battery comprising a polymer as defined in any one of statements 1 to 43, an electrolyte as defined in any one of statements 59 to 66, and/or a cathode as defined in any one of statement 68 to 71.
   73. The battery of statement 72, wherein the battery comprises an electrolyte as defined in any one of statements 59 to 66 disposed between an anode and a cathode.
   74. The battery of statement 72, wherein the battery comprises an electrolyte as defined in any one of statements 59 to 66, said electrolyte being provided as an interlayer located between a ceramic electrolyte (e.g., argyrodite Li₆PS₅Cl) and an anode and/or cathode.
   75. The battery of statement 72, wherein the battery comprises a cathode as defined in statement 70, wherein a ceramic electrolyte (e.g., argyrodite Li₆PS₅Cl) is disposed between the cathode and an anode.
   76. Use of a polymer as defined in any one of statements 1 to 43 in the manufacture of a battery or a battery component (e.g. an electrolyte or a cathode).

### EXAMPLES

One or more examples of the invention will now be described, for the purpose of illustration only, with reference to the accompanying figures:

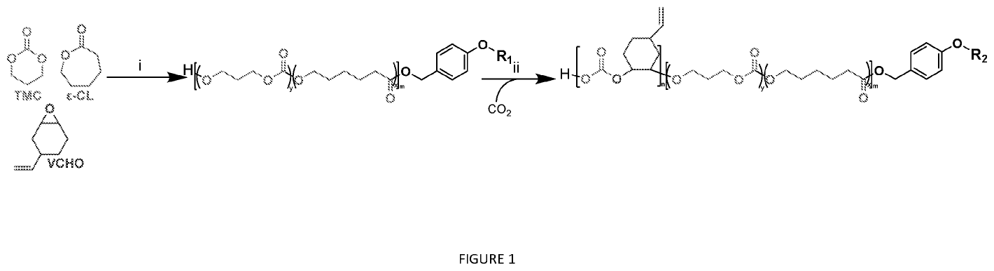

FIG. 1. ROP of ε-CL and TMC followed by ROCOP of VCHO with CO₂ to produce the copolymer PVCHC-PCL/PTMC via switch catalysis. When producing triblock copolymers, R₁=poly(CL-r-TMC) and R₂=(CL-r-TMC-b-VCHC). When producing diblocks, R₁=R₂═H. (i) ROP was conducted at 100° C. for 10 minutes in a reaction mixture that is 26 mL, 40% VCHO and 60% toluene by volume. Typical molar ratio: [LZn₂Ph₂]/[CTA]/[TMC]/[CL]/[VCHO]=1/4/375/1500/3000, where [CTA], [ε-CL], and [TMC] are adjusted to achieve the desired composition and Mₙ. To produce triblock copolymers, the chain transfer agent (CTA) benzene dimethanol (BDM) was used; methyl benzyl alcohol (Me-BnOH) was used to produce diblocks. The catalyst concentration was 0.92 mM. (ii) The reaction vessel temperature was maintained at 100° C. and the vessel atmosphere was changed to 1 bar CO₂ to initiate a mechanistic switch to VCHO/CO₂ ROCOP.

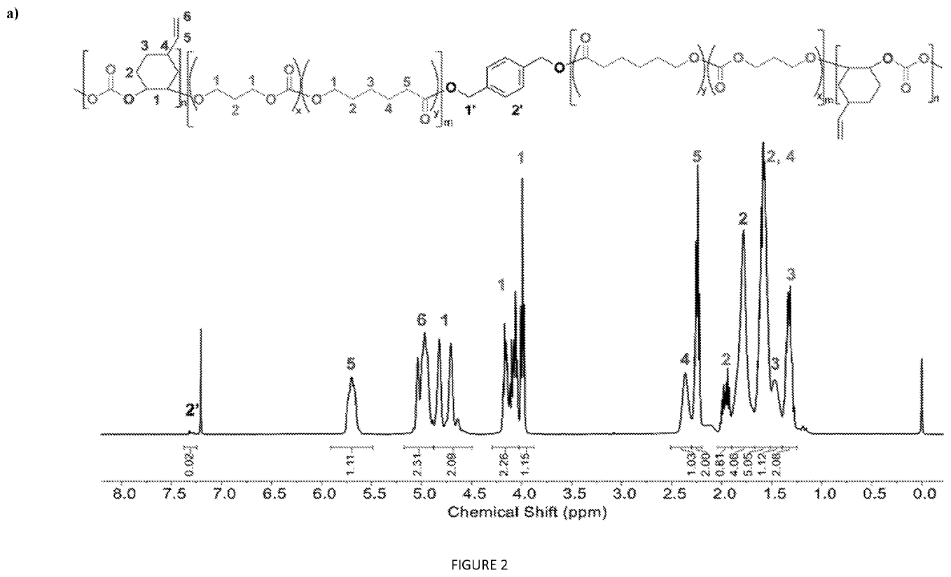

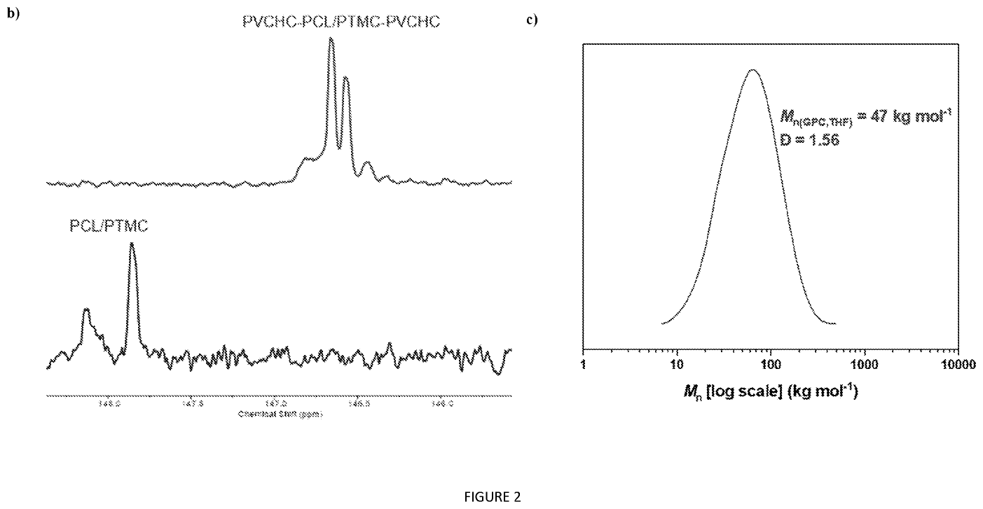

FIG. 2. Exemplar polymer characterisation data. (a) Assigned ¹H NMR spectrum (CDCl₃) of the purified block polymer PVCHC-PCL/PTMC-PVCHC. (b) ³¹P{H} spectra (CDCl₃) after reaction of the polymer hydroxyl end groups with 2-chloro-4,4,5,5-tetramethyldioxaphospholone. Top: Tri-block copolymer PVCHC-PCL/PTMC-PVCHC, displaying PVCHC-OH end groups. Bottom: Homopolymer PCL/PTMC, displaying PCL-OH and PTMC-OH end groups. (c) GPC trace for the polymer sample ABA(44, 0.53), conducted with a THF eluent and calibrated to a polystyrene standard.

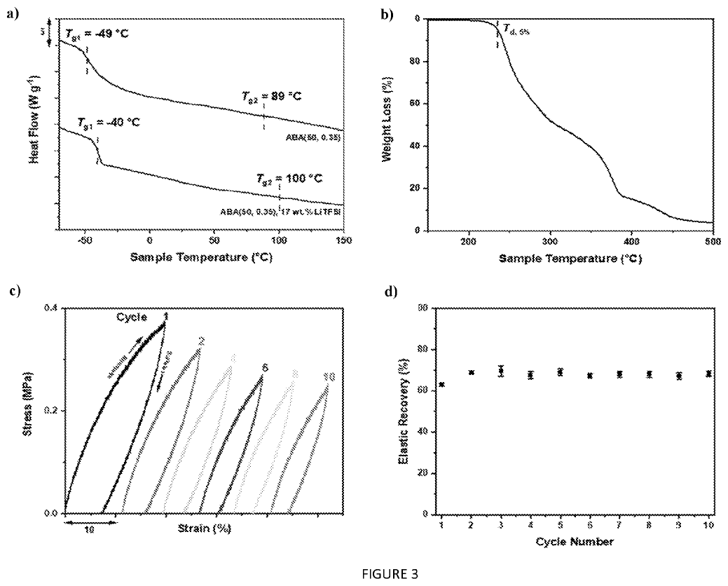

FIG. 3. Thermal and mechanical behaviour of the ABA(50, 0.35) polymer electrolyte film, with 17 wt. % LiTFSI. (a) DSC trace for: ABA(50, 0.35) (top) exhibiting a lower T_{g1} at −49° C. and a weak upper T_{g2} at 89° C.; ABA(50,0 0.35) with 17 wt. % LiTFSI, exhibiting a lower T_{g1} at −40° C. and a weak upper T_{g2} at 100° C. (b) TGA trace for ABA(44, 0.53) with 17 wt. % LiTFSI. (c) Cyclic tensile testing (20% strain, 10 mm min⁻¹ extension rate). (d) Elastic recovery at zero stress after 20% strain, defined as 100×(ε_{20%}−ε(0,ε_{20%}))/ε_{20%}, where ε_{maX} and ε(0, ε_{maX}) are the maximum strain and the strain in the cycle at zero stress after the maximum strain ε_{maX}, as a function of cycle number.^{[10]}

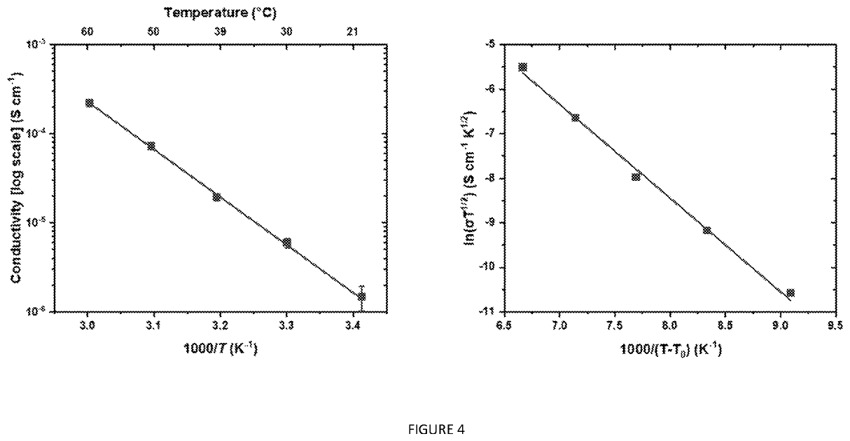

FIG. 4. Li-ion conductivity data for ABA(50, 0.35) with 17 wt. % LiTFSI. (a) Li-ion conductivity as a function of temperature, obtained by electrochemical impedance spectroscopy. (b) VFT fit.

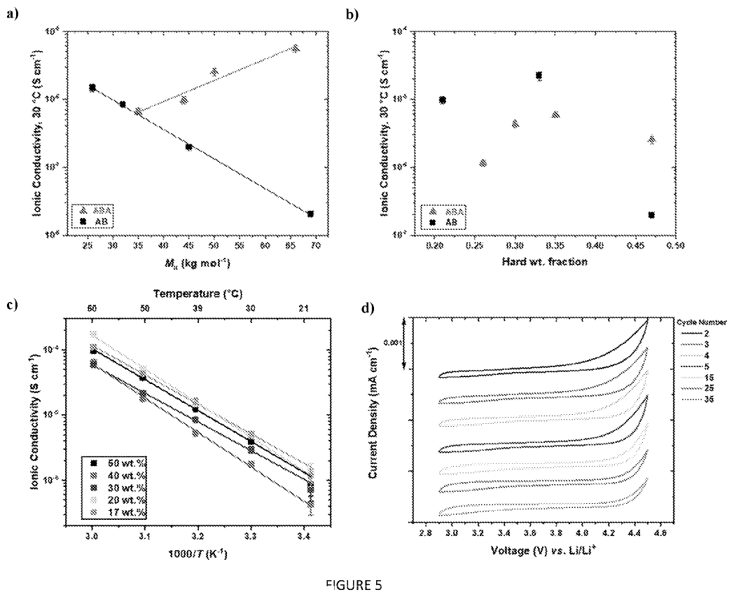

FIG. 5. Plots exploring the relationship of the ionic conductivity of the polymer electrolytes to the polymer's, M_{n′} hard wt., and the wt. % LiTFSI; and further electrochemical data. (a): The ionic conductivity of the materials at 30° C. in relation to the polymer's M_{n′} for both triblock and diblock copolymers, where all polymers have a fixed hard weight fraction of 0.5. (b) The ionic conductivity of the polymer electrolytes at 30° C. in relation to the polymer's hard weight fraction, for both triblock and diblock copolymers, where all polymers have a fixed Mₙ of approximately 50 kg mol⁻¹. (c) Li-ion conductivity data showing the effect of salt concentration. Samples of ABA(50, 0.35) with 50, 40, 30, 20, and 17 wt. % LiTFSI have been studied. (d) Cyclic voltammetry for ABA(50, 0.35) polymer electrolyte with 17 wt. % LiTFSI with a cell configuration of lithium vs. stainless steel, measured at 60° C. at a sweep rate of 0.5 mV s⁻¹.

### MATERIALS AND METHODS

### Materials

All solvents and reagents were purchased and used as obtained from commercial sources (Sigma Aldrich) unless stated otherwise. The synthesis of 4-tert-butyl-2,6-diformylphenol, [H₄L])(ClO₄)₂ and H₂L were carried out in air.^{[11]} The synthesis of the catalyst, [LZn₂(Ph)₂],^{[10]]} monomer purification and subsequent polymerisations were carried out under inert conditions using standard Schlenk line techniques and a nitrogen-filled glovebox. Vinyl cyclohexenoxide (VCHO) and ε-caprolactone (ε-CL) were dried by stirring over CaH₂, distilled under reduced pressure and stored under nitrogen. 1,4-Benzene dimethanol (BDM) was recrystallized from toluene three times and kept under nitrogen. Trimethylene carbonate (TMC) was purchased from TCI. It was recrystallized from dry Et₂O under a nitrogen atmosphere and dried in vacuo before use.

### NMR

¹H and ³¹P{H} NMR spectra were obtained using a Bruker AVIII HD 400 NMR spectrometer. ¹³C{H} NMR spectra were obtained using a Bruker AVII 500 NMR spectrometer.

### GPC

GPC data was obtained using a Shimadzu LC-20AD instrument equipped with a Refractive Index (RI) detector and two PSS SDV 5 μm linear M columns. HPLC grade THF was used as the eluent, flowing at 1.0 mL/min at 30° C. A monodisperse polystyrene standard was used for calibration. Samples were passed through 0.2 μm syringe filters prior to analysis.

### DSC

DSC of the polymers was conducted using a DSC3+ (Mettler-Toledo Ltd) instrument. A sealed, empty crucible was used as a reference and the DSC was calibrated using zinc and indium. Samples were cooled from 25° C. to −80° C. at a rate of 20° C. min⁻¹ under a N₂ flow (80 mL min⁻¹) followed by a 5 minute isotherm at −80° C. Samples were then heated to 200° C. at a rate of 20° C. min⁻¹; kept at 2000° C. for a further 5 minutes; followed by a cooling-heating procedure from 200° C. to −80° C. at 10° C. min⁻¹. Glass transition temperatures (T_{g}) were reported as the midpoint of the transition taken from the third second cycle.

### TGA

TGA was conducted on a TGA/DSC 1 (Mettler Toledo Ltd) system. Polymer samples were heated from 30 to 500° C. at a rate of 5° C. min⁻¹, under an N₂ flow (100 mL min⁻¹).

### Tensile Measurements

For tensile testing, dumbbell specimens were cut according to ISO 527-2, specimen type 5B with Zwick ZCPO20 cutting press (length=35 mm, gauge length=10 mm, width=2 mm). Uniaxial extension measurements were carried out on a Shimadzu EZ-LZ Universal testing instrument at an extension rate of 10 mm min⁻¹ to derive stress-strain relationships.

### Electrochemical Impedance Spectroscopy

Ionic conductivity was measured by impedance spectroscopy using an MTZ-35 Impedance Analyzer (Biologic) over the frequency range 10 MHz-0.01 Hz with the amplitude set to 10 mV. The electrolytes were sandwiched between gold electrodes in a Controlled Environment Sample Holder which was then enclosed in an Intermediate Temperature System. Measurements were taken at 10° C. intervals between 2° and 70° C. The samples were equilibrated at each temperature for 20 min before a new recording was made. The resistance was calculated with EBioLabs using a modified Debye equivalent circuit.

### Voltammetry

Linear sweep and cyclic voltammetry were conducted on a VMP2 (Bio-Logic). Between two stainless steel discs, a 4 mm disc of ABA(50, 0.35) and a 3 mm lithium disc were sandwiched. The cell was annealed at OCV for 3 h at 60° C. before cycling was performed at 0.5 mV s⁻¹. All procedures were carried out in an argon-filled glovebox.

### Experimental

### Synthesis of H₂L

The ligand was synthesised according to the published procedure.^{[10]} [H₄Ln](ClO₄) (5.0 g, 6.7 mmol) and MeOH (500 mL) were added to a round-bottom flask to obtain a red/orange solution. The solution was cooled to 0° C. before the slow addition of NaBH₄ (7.58 g, 200 mmol) to yield a colourless solution. The solution was left stirring at room temperature for 1 h before water was added until precipitation was observed (400 mL). The resultant suspension was left standing for 10 h before being filtered, washed with water and dried under vacuum, at 40° C., to yield a white solid. The precipitate was crystallised from MeOH to yield white crystals (2.56 g, 4.63 mmol, 72%). ¹H NMR (400 MHz, CDCl₃, 298 K): δ(ppm)=6.93 (s, 4H, Ar—H), 3.73 (s, 8H, CH₂), 2.52 (s, 8H, CH₂), 1.25 (s, 18H, CH₃), 1.01 (s, 12H, CH₃).

Synthesis of [LZn₂(Ph)₂]

The catalyst was synthesised according to the published procedure.^{[10]} Under anaerobic conditions, two separate solutions of [H₂L](0.40 g, 0.7 mmol) in THF (5 mL) and ZnPh₂ (0.25 g, 1.2 mmol) in THF (2 mL) were pre-cooled to −40° C. before being added to a glass vial together to obtain a cloudy solution. The mixture stirred for 25 h at 25° C. and filtered to obtain a white solid (260 mg, 0.311 mmol, 55%).

### Switch Catalysis of VCHO, CO₂, TMC, and ε-CL

In the glovebox, TMC was added to 1,4-BDM, followed by ε-CL, VCHO, toluene, and LZn₂Ph₂. The reaction vessel was sealed, taken outside of the glovebox and heated to 100° C., with rapid stirring. At 90% ε-CL conversion (approx. 20 min), the reaction vessel atmosphere was changed to 1 bar CO₂. At 15% VCHO conversion (approx. 30 h), the reaction vessel was cooled, opened to the atmosphere, and 0.2 mL of 0.1 M benzoic acid in chloroform was added, stirring. The conversion of ε-CL and VCHO was determined by ¹H NMR spectroscopic analysis of the crude reaction mixture. The reaction mixture was precipitated three times from methanol (3×200 mL) to yield a white polymer. The material was dried in vacuo and the block copolymer was isolated as a colourless solid (c.a. 2 g). See FIG. 1a for an exemplar assigned ¹H NMR spectrum; see Table 3 for the reagent quantities used to produce various tri- and diblock copolymers.

TABLE 1
Reagent quantities for the synthesis of triblock
and diblock poly(carbonate-b-ester-r-carbonate).

| | LZnPh₂ ^{b} | CTA ^{c} | ε-CL ^{d} | TMC ^{d} | VCHO ^{d} |
|---|---|---|---|---|---|
| Entry ^{a} | (mmol) | (mmol) | (mmol) | (mmol) | (mmol) |
| ABA(35, 0.52) | 0.024 | 0.114 | 15.4 | 3.8 | 82.5 |
| ABA(44, 0.53) | 0.024 | 0.091 | 15.1 | 3.8 | 84.1 |
| ABA(50, 0.47) | 0.024 | 0.080 | 11.2 | 2.8 | 74.6 |
| ABA(66, 0.52) | 0.024 | 0.061 | 15.4 | 3.8 | 82.5 |
| ABA(51, 0.26) | 0.024 | 0.078 | 23.7 | 5.9 | 41.3 |
| ABA(47, 0.30) | 0.024 | 0.085 | 22.4 | 5.6 | 47.6 |
| ABA(50, 0.35) | 0.024 | 0.080 | 20.8 | 5.2 | 55.6 |
| ABA(60, 0.62) | 0.024 | 0.067 | 12.2 | 3.0 | 98.4 |
| AB(26, 0.45) | 0.024 | 0.154 | 17.6 | 4.4 | 71.4 |
| AB(32, 0.51) | 0.024 | 0.125 | 15.7 | 3.9 | 81.0 |
| AB(45, 0.47) | 0.024 | 0.089 | 17.0 | 4.2 | 74.6 |
| AB(69, 0.58) | 0.024 | 0.058 | 15.4 | 3.8 | 92.1 |
| AB(37, 0.21) | 0.024 | 0.108 | 25.3 | 6.3 | 33.3 |
| AB(54, 0.33) | 0.024 | 0.074 | 11.8 | 2.9 | 52.4 |

^{a} Entries named ABA(X, Y) for triblock copolymers and AB(X, Y) for diblock copolymers, where X is M_{n, NMR} and Y is the hard wt. fraction;
^{b} Quantity of catalyst, LZn₂Ph₂, in the reaction mixture;
^{c} Quantity of chain transfer agent (CTA). Benzene dimethanol (BDM) used to make triblock copolymers, methylbenzylalcohol (MeBnOH) used to make diblock copolymers;
^{c} Quantity of ε-CL, TMC, and VCHO in the reaction mixture. The total volume is made up to 26 mL with toluene.

### Results and Discussion

### Polymer Synthesis

PVCHC-PCL/PTMC-PVCHC and the corresponding diblock polymer PVCHC-PCL/PTMC were produced by switch catalysis, using a LZn₂Ph₂ catalyst which was synthesised according to the literature.^{[11]} LZn₂Ph₂ is known to be active for both lactone ROP and epoxide/CO₂ ROCOP and is able to polymerise selectively from a monomer mixture.^{[12]} It has phenyl co-ligands: these are unable to initiate polymerization but can react in-situ with an alcohol initiator to produce the initiating species. This produces hydroxy-telechelic polymers only; this is an important attribute when targeting ABA and AB block polymers. A typical polymerisation was conducted using a relative ratio of 1/4/375/1500/3000 of LZn₂Ph₂/chain transfer agent/TMC/ε-CL/VCHO. The reaction mixture was 26 mL: by volume, approximately 40% VCHO and 60% toluene. The optimal catalyst concentration was 0.92 mM. For the triblock copolymer, 1,4-benzenedimethanol (BDM) was used as the chain-transfer agent; 4-methylbenzyl alcohol (Me-BnOH) was used to produce diblocks. Experiments were stirred at 1600 rpm and heated to 100° C.

To aid the systematic investigation of properties, two series of triblock polymers have been targeted: those with a fixed hard wt. % and different molecular weight (Mₙ) (ABA(X, 0.50), and those with a fixed Mₙ and different hard wt. % (ABA(˜50, Y)) (Table 1). Both Mₙ and hard-block content influence achieving phase-separated nanostructures and thus affect the physical properties of the polymer. The ratio of chain transfer agent, ε-CL, TMC, and VCHO were adjusted to produce the desired polymer weight and composition. By using a mono-functional initiator, a series of AB diblock polymers, featuring the same systematic variations in Mₙ and hard-block content, were also prepared.

Initially, ROP of ε-CL and TMC produced poly(CL-r-TMC) (FIG. 1). By ¹H NMR spectroscopy of the crude reaction mixture, it was shown that 90% ε-CL conversion was reached after 20 minutes. At this point, the reaction vessel atmosphere was changed to 1 bar CO₂ to initiate a mechanistic switch to VCHO/CO₂ ROCOP. This proceeded from the polyester chain ends and produced the ABA triblock copolymer PVCHC-PCL/PTMC-PVCHC (Scheme 1). The ROCOP was allowed to proceed for 30 hours. After that, the reaction mixture was quenched by addition of 0.2 mL of a 0.1 M benzoic acid solution in chloroform: this reacts with the catalyst to stop the polymerization. Crude polymer samples were analysed by ¹H NMR spectroscopy to determine monomer conversion of ε-CL and VCHO by integration of the peaks corresponding to the monomer (δ=2.70, 4.87 ppm) and polymer (δ=4.14, 3.20 ppm). This was not possible for TMC as its signals overlapped with ε-CL. The polymer was purified by precipitation from methanol, dried in vacuo, and characterized using ¹H NMR spectroscopy, ³¹P{H} end-group analysis, diffusion-ordered NMR spectroscopy (DOSY), and gel permeation chromatography (GPC).

In the ¹H NMR spectrum of the purified polymer, the expected signals were observed corresponding to PVCHC and PCL-r-PTMC. Integration of the peaks revealed the molar composition of the polymer (FIG. 2a). As the signals attributed to TMC (4.08-4.25, 1.99 ppm) both show some overlap with ε-CL and VCHO signals respectively, it is difficult to observe their ratios; however, the polymers are estimated to be 20 mol % TMC, as targeted. The polymerisation is highly selective for polyester and polycarbonate formation as ether linkages were not observed (3.30-3.60 ppm). Due to the high molar masses of the polymers, block junction signals were not detectable. Repeated precipitations of the polymer did not change the polymer composition, supporting the formation of a block copolymer rather than a blend. Chain end-group analysis was conducted by ³¹P{H} NMR spectroscopy after reaction of the polymers' α,γ-hydroxyl groups with a phosphorous reagent, according to a literature procedure.^{[}13] The vinyl cyclohexenol end group signal (146.6 ppm) was observed, indicative of selective block copolymer formation (FIG. 2b). The block structure was further evidenced by DOSY. A single diffusion coefficient was observed, indicative of joined blocks of PVCHC and PCL/PTMC; if a homopolymer blend was instead present, two distinct diffusion coefficients would be observed.

The molecular weight of the polymer was estimated by ¹H NMR spectroscopy and GPC, plus the theoretical value can be calculated from the monomer/initiator ratio and the monomer conversions. There was good agreement between DP_{calc} and DP_{NMR}, suggesting that there were few impurities such as H₂O to act as additional chain transfer agents (Table 1). GPCs have been conducted with a THF eluent. Monomodal mass distributions were observed and polymers showed high Mₙ (FIG. 2c). This supports the formation of one type of polymer chain, rather than a mixture of homopolymer and block copolymer. For most samples, there was good agreement between M_{n,NMR} and M_{n,GPC} (Table 1). A narrow polydispersity index (D) was not expected for this polymer.^{[14]} ε-CL provides a primary propagating site for ROP, thus there is a broader dispersity. Some polymers show a disparity between M_{n,NMR} and M_{n,GPC}—particularly, ABA(66, 0.52), ABA(50, 0.35), and AB(69, 0.58). This is likely due to a GPC effect: differences in M_{n,NMR} and M_{n,GPC} for other polymers have previously been reported.^{[15]} It can be attributed to polycarbonates exhibiting different chain-folding behaviour to polystyrene, which the column is calibrated to. This results in a lower hydrodynamic volume, so a lower measured molar mass value.

TABLE 2
Characterisation data for the triblock and diblock copolymers

| | DP_{PC}-DP_{PE}- | DP_{PC}-DP_{PE}- | | M_{n, NMR}^{c} | M_{n, GPC, THF}^{d} | | | |
|---|---|---|---|---|---|---|---|---|
| | DP_{PC} | DP_{PC} | M_{n, NMR, ABA}^{c} | (kg | (kg mol⁻¹) | Hard | T_{g1}, T_{g2}^{e} | T_{d, 5%}^{f} |
| Entry^{a} | (calc)^{b} | (NMR)^{c} | (kg mol⁻¹) | mol⁻¹) | [Ð] | wt. %^{c} | (° C.) | (° C.) |
| ABA(35, 0.52) | 52-144-52 | 54-157-54 | 9-17-9 | 35 | 29 [1.69] | 52 | −38, 89 | 204 |
| ABA(44, 0.53) | 70-182-70 | 70-194-70 | 12-21-12 | 44 | 47 [1.56] | 53 | −40, 102 | 235 |
| ABA(50, 0.47) | 73-274-73 | 70-250-70 | 12-27-12 | 50 | 40 [2.03] | 47 | −43, 84 | 242 |
| ABA(66, 0.52) | 99-258-99 | 102-266-102 | 17-29-17 | 66 | 45 [1.58] | 52 | −47, 98 | — |
| ABA(51, 0.26) | 47-366-47 | 40-352-40 | 7-38-7 | 51 | 28 [1.75] | 26 | −31, 81 | — |
| ABA(47, 0.30) | 46-323-46 | 42-315-42 | 7-34-7 | 47 | 49 [1.52], | 30 | −49, 95 | 240 |
| | | | | | 8 [1.18] | | | |
| ABA(50, 0.35) | 55-359-55 | 52-306-52 | 9-33-9 | 50 | 35 [1.89] | 35 | −48, 89 | 241 |
| ABA(50, 0.62) | 85-176-85 | 93-176-93 | 16-19-16 | 50 | 50 [1.85] | 62 | −48, 94 | 230 |
| AB(26, 0.45) | 88-152 | 70-139 | 13-15 | 26 | 26 [1.63] | 45 | −49, 92 | 210 |
| AB(32, 0.51) | 106-160 | 95-152 | 16-16 | 32 | 45 [1.52] | 51 | −37, 88 | — |
| AB(45, 0.47) | 100-236 | 126-215 | 12-13 | 45 | — | 47 | — | — |
| AB(69, 0.58) | 286-280 | 238-261 | 88-64 | 69 | 69 [1.68] | 58 | −56, 113 | 231 |
| AB(37, 0.21) | 60-340 | 54-315 | 9-34 | 37 | 37 [1.70] | 21 | −51, 92 | 216 |
| AB(54, 0.33) | 120-369 | 107-343 | 18-36 | 54 | 21 [1.90] | 33 | −43, 81 | — |

^{a}Entries named ABA(X, Y) for triblock copolymers and AB(X, Y) for diblock copolymers, where X is M_{n, NMR} and Y is the hard wt. fraction;
^{b}Calculated from the initial [ε-CL + TMC + VCHO]₀/[BDM]₀ ratio and the monomer conversions;
^{c}Determined from the ¹H NMR spectra of the purified polymer by integration of the aromatic initiator resonance (7.34 ppm for 1,4-BDM, 7.17 ppm for Me—BnOH) against those of PVCHC (5.76 ppm) and PCL/PTMC (2.00, 1.38 ppm);
^{d}Mₙ of the overall block copolymer determined by GPC with THF eluent, calibrated using PS standards;
^{e}Estimated by DSC (10° C. min⁻¹ heating rate), third heating curve;
^{f}Thermal degradation temperature of the polymer with 17 wt. % LiTFSI, determined by TGA. Recorded as the temperature at 5% mass loss.

### Thermal Properties

Thermal data was obtained using DSC. Polymers were fully amorphous and possessed a strong lower T_{g} at around −40° C., corresponding to the inner poly(CL-r-TMC) block, and a weaker upper T_{g} at around 100° C., corresponding to the hard poly(VCHO-alt-CO₂) block (FIG. 3a). The T_{g} values are consistent with the literature, where T_{g}=106° C. is reported for PVCHC,^{[16]} and T_{g}=−56° C. for PCL/PTMC.^{[14]} The observation of upper and lower T_{g} values close to the homopolymer values demonstrated that there is phase separation in the polymer. This is desirable for good mechanical properties: flexibility, extensionability, elastic recovery, high temperature stability, and tensile strength.

As these polymers are being investigated for battery applications, it is pertinent to study their properties after the addition of lithium salt. Lithium bis(trifluoromethanesulfonyl)imide (LiTFSI) was chosen as this salt is widely used in studies relating to Li-ion batteries.^{[17]} To the polymers, 17 wt. % of LiTFSI was added (relative to the overall polymer Mₙ) and electrolyte films were prepared by solvent casting.^{[18]}

The DSC traces of the polymers with salt retain their amorphous nature and exhibit a shift in T_{g} relative to the pure polymer (FIG. 3a). ABA(50, 0.35) showed an increase in the upper and lower T_{g} on salt addition. The lower T_{g} corresponds to the polyester block poly(CL-r-TMC): salt enables transient crosslink formation within this block, as observed in the literature.^{[17, 19]} With regards to the upper T_{g}, Kimura et al. have shown that the T_{g} of polyethylenecarbonate-based electrolytes increases from 0 to 10 wt. % salt, likely due to interaction between the carbonyl oxygen and Li ions.^{[20]} This supports the upper T_{g}, corresponding to the polycarbonate PVCHC, increasing.

The thermal stability of the polymers have been measured with the addition of 17 wt. % LiTFSI. For all polymers, T_{d,5 %} is above 200° C. (Table 1): this is sufficiently high for the desired application. The TGA trace shows three different regions: 200-270° C. corresponds to decomposition of the poly(CL-r-TMC) block; 270-385° C. corresponds to decomposition of the PVCHC block; and 385-500° C. to the decomposition of LiTFSI (FIG. 3b).

### Mechanical Properties

The elastic recovery of the ABA(50, 0.35) polymer electrolyte film with 17 wt. % LiTFSI was determined: the ability of the material to return to its original shape after strain. In a battery, polymers will experience stress and strain during charge and discharge cycles thus this is a key parameter. Dumbbell-shaped specimens were cut from the polymer film using a cutting press.

Three ABA(50, 0.35) samples were tested: the mean is reported and the errors are represented by standard deviations. Each sample was subjected to 10 hysteresis cycles to 20% strain at an extension rate of 10 mm min⁻¹. This strain was used as it is a little above the volume change experienced by high-capacity cathode particles.^{[21]} The first elastic cycle differs to those subsequent due to the initial disentangling of polymer chains. An elastic recovery of 70% was recorded: this was lower than what would be seen from an ideal elastomer but nevertheless demonstrates that the material shows recovery after experiencing strain (FIGS. 4c, 2d).

### Ion Transport

Li-ion conductivity measurements have been obtained for the polymers in the series (Table 3) using electrochemical impedance spectroscopy (EIS) in a 2-electrode cell. Electrolyte films of ˜250 μm thickness were prepared by solvent casting the polymer plus 17 wt. % LiTFSI from a THF solution (20 wt. %) in a Teflon mould. It was dried by solvent evaporation under ambient pressure and an N₂ atmosphere for 48 h, and then in vacuo at 40° C. for a further 72 h. Measurements were taken at 10° C. temperature intervals between 2° and 70° C.

The triblock and diblock copolymer with the highest ionic conductivity at 30° C. were ABA(50, 0.35) and AB(37, 0.21) respectively: 5.9×10⁻⁶ S cm⁻¹ and 9.8×10⁻⁶ S cm⁻¹. Plots of ionic conductivity against temperature have been produced for each sample and is shown for ABA(50, 0.35) (FIG. 4a). Ionic conductivity increased with temperature: from 5.9×10⁻⁶ S cm⁻¹ at 30° C. to 7.2×10⁻⁵ S cm⁻¹ at 70° C. This is due to increasing polymer chain mobility with increasing temperature, consequently increasing ion mobility.

The temperature dependence of ionic conductivity can be modelled by the Vogel-Fulcher-Tammann (VFT) fit (FIG. 4b), a modified Arrhenius equation, by plotting equation 1:

$$σ = A {T}^{- 1 / 2} exp [ - B / ( T - {T}_{0} ) ] \qquad ( 1 )$$

where A is a constant proportional to the number of carrier ions, B is related to the activation energy of Li⁺ movement, and T₀ is the temperature where configurational entropy is zero (T₀≈T_{g}−50 K).

For the polymers studied, the plot shows a linear relationship. This indicated an ionic conductivity mechanism where ions hop between vacant coordination sites, aided by the segmental motion of the polymer. This was true for all of the polymers studied. The gradient of the plot allows the activation energy of the electrolyte to be calculated: this was 17.4 kJ mol⁻¹ for ABA(51, 0.35). This value was higher than obtained for poly(CL-r-TMC) (9.4 kJ mol⁻¹), as reported by Mindemark et al.^{[14]} This suggests that the presence of the PVCHC hard block produced an additional energy barrier for ion movement. Here, there was a positive correlation between Eₐ and InA, akin to the observation made by Balsara et al. for a poly(styrene-b-ethylene oxide) electrolyte.^{[22]} Consequently, a lower Eₐ does not necessarily correspond to a higher ionic conductivity because there are also fewer carrier ions.

TABLE 3
Li-ion conductivity data for ABA and AB polymers

| | Mₙ | Hard | T_{g1}, T_{g2}^{c} | σ_{70° C.}^{di} | σ_{28° C.}^{dii} | Eₛ^{e} | |
|---|---|---|---|---|---|---|---|
| Entry^{a} | (kg mol⁻¹)^{b} | wt. %^{b} | (° C.) | (S cm⁻¹) | (S cm⁻¹) | (kJ mol⁻¹) | lnA^{f} |
| ABA(35, 0.52) | 35 | 52 | −49, 101 | 5.6 × 10⁻⁵ | 6.6 × 10⁻⁷ | 15.3 | 5.6 |
| ABA(44, 0.53) | 44 | 53 | −48, 102 | 2.2 × 10⁻³ | 9.8 × 10⁻⁷ | 8.7 | 2.9 |
| ABA(50, 0.47) | 50 | 47 | −48, 100 | 4.9 × 10⁻⁵ | 2.6 × 10⁻⁶ | 13.0 | 0.0 |
| ABA(66, 0.52) | 66 | 52 | −32, 100 | 5.6 × 10⁻³* | 5.5 × 10⁻⁵ | 12.8 | 6.3 |
| ABA(51, 0.26) | 52 | 26 | −38, 98 | 9.9 × 10⁻⁵ | 1.2 × 10⁻⁶ | 16.0 | 7.3 |
| ABA(47, 0.30) | 47 | 30 | −33, 66 | 2.6 × 10⁻⁵** | 4.3 × 10⁻⁵ | 11.2 | 2.5 |
| ABA(50, 0.35) | 50 | 35 | −40, 100 | 2.2 × 10⁻⁴* | 5.9 × 10⁻⁶ | 17.0 | 8.3 |
| ABA(50, 0.62) | 50 | 62 | −32, 85 | 3.8 × 10⁻⁵ | 1.4 × 10⁻⁶ | 14.6 | 1.7 |
| AB(26, 0.45) | 28 | 45 | −52, 96 | 4.4 × 10⁻⁵ | 1.5 × 10⁻⁶ | 15.4 | 4.0 |
| AB(32, 0.51) | 32 | 51 | −37, 84 | 1.9 × 10⁻⁵** | 8.4 × 10⁻⁷ | 23.6 | 12.5 |
| AB(45, 0.47) | 45 | 47 | −19, 102 | 2.2 × 10⁻³ | 2.0 × 10⁻⁷ | 9.1 | 3.8 |
| AB(69, 0.58) | 69 | 58 | −20, 94 | 1.9 × 10⁻⁵ | 2.1 × 10⁻⁸ | 8.8 | 0.9 |
| AB(37, 0.21) | 37 | 21 | — | 5.8 × 10⁻⁵** | 9.8 × 10⁻⁶ | 14.5 | 2.6 |
| AB(54, 0.33) | 54 | 33 | −42, 82 | 1.6 × 10⁻⁴ | 2.2 × 10⁻⁵ | 10.0 | 2.6 |

^{a}Entries named ABA(X, Y) for triblock copolymers and AB(X, Y) for diblock copolymers, where X is M_{n, NMR} and Y is the hard wt. fraction;
^{b}Determined from the ¹H NMR spectra of the purified polymer by integration of the aromatic initiator resonance (7.34 ppm for 1,4-BDM, 7.17 ppm for Me—BnOH) against those of PVCHC (5.76 ppm) and PCL/PTMC (2.00, 1.38 ppm);
^{c}Lower (T_{g1}) and upper (T_{g2}) glass transition temperatures of the polymer with 17 wt. % LiTFSI, estimated by DSC (10° C. min⁻¹ heating rate), third heating curve;
^{d}Ionic conductivity was measured using impedance spectroscopy. The ionic conductivity was calculated from the resistance that was obtained by fitting the acquired data to a modified Debye circuit;^{[23]}
^{di}Li-ion conductivity at 70° C., except for values labelled * which were conducted at 60° C. and ** which were conducted at 50° C., values have a 9% error
^{dii}Li-ion conductivity at 30° C., values have an 11% error;
^{e}Activation energy of Li-ion transfer, obtained from the VFT fit;
^{f}Relative free charge carrier concentration of the polymer electrolyte, obtained from the VFT fit.

For this set of polymers, ionic conductivity was not significantly affected by the glass transition temperature of either the soft or hard block. When T_{g1} was between −53 and −33° C., there was no significant trend between T_{g1} and ionic conductivity. Polymer samples AB(45, 0.47) and AB(69, 0.58) had T_{g1}'s of −19 and −20° C. and also had the lowest ionic conductivities (2.0×10⁻⁷ S cm⁻¹, 2.1×10⁻⁷ S cm⁻¹). This suggests that for this system, lowering T_{g1} is an effective strategy for improving ionic conductivity until −20-−33° C.; below this, other factors become more important.^{[19]}

The relationship between the ionic conductivity of the materials and their Mₙ and hard wt. % has been explored. Triblock polymers with a fixed hard weight fraction of 0.5 showed an increase in ionic conductivity at 30° C. as their Mₙ is increased: a 10-fold increase was observed between ABA(35, 0.52) and ABA(66, 52). The opposite trend was observed for diblocks: as their Mₙ increased, their ionic conductivity decreased (FIG. 5a). For the triblock copolymers, this could be due to the high Mₙ polymers having a larger grain size.^{[19]} This is this is an encouraging finding as the higher Mₙ polymers will likely show improved mechanical properties, such as a higher storage modulus. For the diblocks, higher Mₙ led to a significantly greater T_{g}—for AB(69, 0.58), a 36° C. increase in T_{g1} is observed relative to the pure polymer—this results in a decrease in ionic conductivity.

For triblock copolymers with a fixed Mₙ of approximately 50 kg mol⁻¹, ionic conductivity peaked at a hard weight fraction of 0.35: more or less hard block content resulted in a decreased ionic conductivity. A similar trend was seen for diblock copolymers: the highest ionic conductivity was at a hard weight fraction of 0.33 (FIG. 5b). At this composition, it is likely that the polymer forms a phase which has favourable to ion transport.

The effect of salt concentration on ionic conductivity has been studied on polymer ABA(50, 0.28). Electrolyte films containing 17, 20, 30, 40, and 50 wt. % LiTFSI have been prepared. The optimum amount of LiTFSI for ionic conductivity was 20 wt. % (FIG. 5c). This is because too little salt results in fewer free charge carriers, whereas too much may result in transient crosslinking of the polymer chains.^{[17, 24]} This can be observed in the DSC traces: generally, as salt concentration decreased, the lower T_{g} also decreased.

### Electrochemical Performance

The polymers with the highest ionic conductivity at 30° C. were AB(37, 0.21) (9.8×10⁻⁵ S cm⁻¹) and AB(54, 0.33) (2.2×10⁻⁵ S cm⁻¹). ABA(50, 0.35) demonstrated the best properties overall, and were studied further as the lead polymer.

The electrochemical stability of carbonyl coordinating polymers is often greater than what can be achieved with PEO electrolytes. To assess the electrochemical stability window of this material, linear sweep voltammetry (LSV) was conducted on the ABA(50, 0.35) electrolyte. A lithium|polymer|stainless steel cell configuration was used to evaluate the stability between its open-cell voltage (OCV) and 6 V at 60° C. with a sweep rate of 0.05 mV s⁻¹. Prior to sweeping, the cell was shown to be stable by maintaining the OCV for 3 hours. The polymer is oxidatively stable to above 5 V vs. Li/Li⁺; this suggests compatibility with high voltage cathodes. Its stability is comparable to other polyester and polycarbonate-based electrolytes in the literature, for example poly(CL-r-TMC) (>5 V) and poly(styrene-b-CL-r-TMC) (5 V).^{[14][25]} Cyclic voltammetry was conducted between 3 and 4.5 V on ABA(50, 0.35), using the same cell configuration as in the linear sweep. It showed good oxidative stability across 35 cycles. (FIG. 5d).

### CONCLUSIONS

The synthesis of two different architectures of block copolymers has been achieved by switch catalysis: AB and ABA type polymers have been produced, where A is a polycarbonate block (PVCHC) and B is a poly(ester-co-carbonate) (PCL-r-TMC). Experimental data was consistent with block formation and allowed the hard block wt. % and molar mass values to be measured. Polymer electrolytes have been prepared using LiTFSI salt. All of the polymer electrolytes tested had sufficient thermal stability, with T_{d,5 %}>200° C., and demonstrated phase separation through the observation of an upper and lower T_{g}. The materials showed moderate elastic recovery of 70%, as investigated by cyclic tensile testing.

Li-ion conductivity has been measured using electrochemical impedance spectroscopy. Good conductivity was demonstrated at elevated temperatures (σ_{70° C.}=2.2×10⁻⁴ S cm⁻¹ for ABA(50, 0.35)) and moderate performance at ambient (σ_{30° C.}=5.9×10⁻⁶ S cm⁻¹ for ABA(50, 0.35)). Trends related to polymer composition and architecture were elucidated. Electrochemical performance has been investigated: linear-sweep voltammetry demonstrates that the electrolyte is stable to >5 V, and cyclic voltammetry has successfully cycled the material 35 times between 3 V and 4.5 V.

While specific embodiments of the invention have been described herein for the purpose of reference and illustration, various modifications will be apparent to a person skilled in the art without departing from the scope of the invention as defined by the appended claims.

### REFERENCES

[1]H. Government, (Ed.: D. f. Transport), 2021.
[2]X. Wang, R. Kerr, F. Chen, N. Goujon, J. M. Pringle, D. Mecerreyes, M. Forsyth, P. C. Howlett, Adv. Mater., n/a, 1905219.
[3] aL. Long, S. Wang, M. Xiao, Y. Meng, J. Mater. Chem. A 2016, 10038-10069; bT. Famprikis, P. Canepa, J. A. Dawson, M. S. Islam, C. Masquelier, Nature Materials 2019, 18, 1278-1291; cP. Albertus, V. Anandan, C. Ban, N. Balsara, I. Belharouak, J. Buettner-Garrett, Z. Chen, C. Daniel, M. Doeff, N. J. Dudney, B. Dunn, S. J. Harris, S. Herle, E. Herbert, S. Kalnaus, J. A. Libera, D. Lu, S. Martin, B. D. McCloskey, M. T. McDowell, Y. S. Meng, J. Nanda, J. Sakamoto, E. C. Self, S. Tepavcevic, E. Wachsman, C. Wang, A. S. Westover, J. Xiao, T. Yersak, ACS Energy Letters 2021, 6, 1399-1404.
[4] aY. Kato, S. Hori, T. Saito, K. Suzuki, M. Hirayama, A. Mitsui, M. Yonemura, H. Iba, R. Kanno, Nat. Energy 2016, 1, 16030; bH. Buschmann, J. DÖlle, S. Berendts, A. Kuhn, P. Bottke, M. Wilkening, P. Heitjans, A. Senyshyn, H. Ehrenberg, A. Lotnyk, V. Duppel, L. Kienle, J. Janek, Phys. Chem. Chem. Phys. 2011, 13, 19378-19392.
[5]K. Jeong, S. Park, S.-Y. Lee, J. Mater. Chem. A 2019, 7, 1917-1935.
[6]H. Chen, M. Ling, L. Hencz, H. Y. Ling, G. Li, Z. Lin, G. Liu, S. Zhang, Chem. Rev. 2018, 118, 8936-8982.
[7]D. E. Fenton, J. M. Parker, P. V. Wright, Polymer 1973, 14, 589.
[8] aZ. Geng, N. S. Schauser, J. Lee, R. P. Schmeller, S. M. Barbon, R. A. Segalman, N. A. Lynd, C. J. Hawker, Macromolecules 2020; bE. Tsuchida, H. Ohno, K. Tsunemi, N. Kobayashi, Solid State Ion. 1983, 11, 227-233; cY. Zhao, Y. Bai, W. Li, M. An, Y. Bai, G. Chen, Chem. Mater. 2020.
[9]D. T. H. Jr., N. P. Balsara, 2013, 43, 503-525.
[10]M. R. Kember, P. D. Knight, P. T. R. Reung, C. K. Williams, J. Am. Chem. Soc. 2009, 48, 931-933.
[11]T. T. D. Chen, University of Oxford 2020.
[12] aC. Romain, J. A. Garden, G. Trott, A. Buchard, A. J. P. White, C. K. Williams, Chem. Eur. J. 2017, 23, 7367-7376; bM. R. Kember, J. Copley, A. Buchard, C. K. Williams, Polym. Chem. 2012, 3, 1196-1201.
[13]A. Spyros, D. S. Argyropoulos, R. H. Marchessault, Macromolecules 1997, 30, 327-329.
[14]J. Mindemark, B. Sun, E. Törmä, D. Brandell, J. Power Sources 2015, 298, 166-170.
[15]J. Kimpel, University of Oxford 2019.
[16]H. Zhang, B. Liu, H. Ding, J. Chen, Z. Duan, Polymer 2017, 129, 5-11.
[17]J. Mindemark, M. J. Lacey, T. Bowden, D. Brandell, Prog. Polym. Sci. 2018, 81, 114-143.
[18]A. Bergfelt, G. Hernández, R. Mogensen, M. J. Lacey, J. Mindemark, D. Brandell, T. M. Bowden, ACS Appl. Polym. Mater. 2020, 2, 939-948.
[19]D. M. Pesko, Y. Jung, A. L. Hasan, M. A. Webb, G. W. Coates, T. F. Miller, N. P. Balsara, Solid State Ion. 2016, 289, 118-124.
[20]K. Kimura, J. Motomatsu, Y. Tominaga, J. Phys. Chem. C 2016, 120, 12385-12391.
[21]Y. Shi, X. Zhou, G. Yu, Acc. Chem. Res. 2017, 50, 2642-2652.
[22]M. Chintapalli, T. N. P. Le, N. R. Venkatesan, N. G. Mackay, A. A. Rojas, J. L. Thelen, X. C. Chen, D. Devaux, N. P. Balsara, Macromolecules 2016, 49, 1770-1780.
[23]R. A. Huggins, Ionics 2002, 8, 300-313.
[24]M. A. Ratner, D. F. Shriver, Chemical Reviews 1988, 88, 109-124.
[25]A. Bergfelt, M. J. Lacey, J. Hedman, C. Sångeland, D. Brandell, T. Bowden, RSC Advances 2018, 8, 16716-16725.

1. A polymer having a structure according to Formula I:
A-B-A′ (I)
wherein
A is a polycarbonate block;
A′ is absent or is a polycarbonate block A; and
B is different to A and is a block composed of a poly(ester-co-carbonate) or a polycarbonate.

2. The polymer of claim 1, wherein the polymer has a number average molecular weight (Mₙ) of 15-100 kg mol⁻¹; or
30-55 kg mol⁻¹.

3. (canceled)

4. The polymer of claim 1, wherein the polymer comprises 16-65 wt % of block A; or
30-40 wt % of block A.

5. (canceled)

6. The polymer of claim 1, wherein A has a glass transition temperature, T_{g}, that is ≥60° C.

7. The polymer of claim 1, wherein B has a glass transition temperature, T_{g}, that is ≤0° C.

8. The polymer of claim 1, wherein A′ is a polycarbonate block A, such that the polymer is a tri-block copolymer.

9. The polymer of claim 1, wherein A′ is absent, such that the polymer is a di-block copolymer.

10. The polymer of claim 1, wherein (1) the polymer is a di-block copolymer and has a molecular weight (Mₙ) of 20-70 kg mol⁻¹ and comprises 20-60 wt % of block(s) A, or (2) the polymer is a tri-block copolymer and has a molecular weight (Mₙ) of 45-70 kg mol⁻¹ and comprises 25-65 wt % of block(s) A.

11. The polymer of claim 1, wherein A has a structure according to Formula A-i: 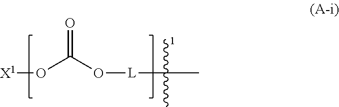
wherein [symbol]
¹ denotes the point of attachment of an oxygen atom, said oxygen atom being a part of B;
X¹ is an end group; and
L is a linking group separating the two oxygen atoms to which it is attached by either:
(i) a distance of 2-3 carbon atoms; or
(ii) a distance of 2 carbon atoms, said 2 carbon atoms forming part of a ring.

12. (canceled)

13. The polymer of claim 1, wherein a proportion of the A and/or B block repeating units independently comprises a pendant neutral functional group FG_{N} selected from —P(O)(OH)₂, —COOH, —OH, —SO₃H, —NH₂, —C(O)NH₂, —F, —CF₃ and —CN, and/or a pendant anionic functional group FG_{A} selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.

14. The polymer of claim 1, wherein A has a structure according to Formula A-ii: 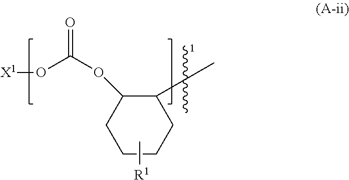
wherein [symbol]
¹ denotes the point of attachment of an oxygen atom, said oxygen atom being a part of B;
X¹ is an end group; and
each R¹ is independently absent or a group —X—(R²)ᵥ, in which
each R² is independently a pendant neutral functional group FG_{N} or a pendant anionic functional group FG_{A}, wherein FG_{N} is selected from —P(O)(OH)₂, —COOH, —OH, —SO₃H, —NH₂, —C(O)NH₂, —F, —CF₃ and —CN, and FG_{A} is selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃;
each v is independently 0 or 1; and
each X is (when v is 1) a linking group that links R² to the cyclohexyl ring, or is (when v is 0) a terminal group.

15. The polymer of f claim 1, wherein B is a poly(ester-co-carbonate).

16. The polymer of any one of claim 1, wherein B is poly(caprolactone-co-trimethylene carbonate) and wherein block B comprises 70-90 mol % of ester repeating units and 10-30 mol % of carbonate repeating units.

17. A process for the preparation of a polymer, the process comprising the steps of:
(a) performing ring-opening polymerisation of: (i) a cyclic carbonate or (ii) a mixture of a cyclic carbonate and a cyclic ester to form a polymeric block B being a polycarbonate or a poly(ester-co-carbonate); and
(b) growing a polymeric block A on one or both ends of the polymeric block B by ring-opening copolymerisation of: (i) an epoxide or an oxetane, and (ii) carbon dioxide.

18. The process of claim 17, wherein ring opening polymerisation in step (a) is initiated using a monofunctional initiator and step (b) comprises growing the polymeric block A on one end of the polymeric block B; or
the ring opening polymerisation in step (a) is initiated using a difunctional initiator and step (b) comprises growing the polymeric block A on both ends of the polymeric block B.

19. (canceled)

20. The process of claim 17, wherein steps (a) and (b) are conducted in a one-pot manner, and wherein step (a) is terminated and step (b) is commenced by the addition of carbon dioxide.

21. The process of claim 17, further comprising the step of:
(c) modifying a proportion of the block A and/or block B repeating units by introducing:
a pendant neutral functional group selected from —P(O)(OH)₂, —COOH, —OH, —SO₃H, —NH₂, —C(O)NH₂, —F, —CF₃ and —CN; and/or
a pendant anionic functional group selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B and —CHFCF₂SO₃⁻.

22. An electrolyte comprising a mixture of a polymer as claimed in claim 1 and a metal salt, wherein the metal salt is of the formula M⁺ X⁻, wherein M⁺ is selected from Na⁻+, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis|(pentafluoroethyl)sulfonyllimide, B(CN)₄⁻, 4,5-dicarbonitrile-1,2,3-triazole, perylene diimide, 4,5-dicyano-2-(trifluoromethyl)imidazolium and combinations of two or more thereof.

23. (canceled)

24. A cathode for a battery, the cathode comprising a polymer as claimed in a claim 1.

25. A battery comprising a polymer as claimed in claim 1.
